(19) United States
(12) Patent Application Publication
(10) Pub. No.: US 2022/0108466 A1
(43) Pub. Date: Apr. 7, 2022

(54) SYSTEM AND METHOD FOR RECONSTRUCTION OF COMPRESSED SIGNAL DATA USING ARTIFICIAL NEURAL NETWORKING

(71) Applicant: Technology Innovation Momentum Fund (Israel) Limited Partnership, Tel-Aviv (IL)

(72) Inventors: David MENDLOVIC, Tel-Aviv (IL); Raja GIRYES, Tel-Aviv (IL); Ofir NABATI, Tel-Aviv (IL); Ido YOVEL, Tel-Aviv (IL)

(73) Assignee: Technology Innovation Momentum Fund (Israel) Limited Partnership, Tel-Aviv (IL)

(21) Appl. No.: 17/426,648

(22) PCT Filed: Jan. 29, 2020
(86) PCT No.: PCT/IL2020/050109

§ 371 Date: Jul. 29, 2021

Related U.S. Application Data
(60) Provisional application No. 62/798,578, filed on Jan. 30, 2019.

(51) Int. Cl. G06T 7/557; H04N 19/167; H04N 19/136; H04N 19/597; G06N 3/08

(52) U.S. Cl. CPC G06T 7/557; H04N 19/167; H04N 19/136; H04N 19/597; G06T 2207/10024; G06T 2207/10052; G06T 2207/20081; G06T 2207/20084; G06N 3/08

(57) ABSTRACT

Presented herein are methods and systems for training a model, specifically a machine learning model, for example, a Deep Neural Network (DNN) for signal reconstruction in an iterative process comprising a plurality of training iterations and use of the trained DNN thereof. Each of the iterations comprises receiving a record associating a compressed signal created according to a sensing matrix selected from a plurality of sensing matrixes with a respective signal originated from a signal source and used for compressing the at least one compressed signal according to the selected sensing matrix, feeding the record and the sensing matrix to train a model and outputting the trained model which may be used for reconstructing one or more new signals originated from the signal source. Wherein at least two of the plurality of sensing matrixes are fed during at least two separate iterations of the plurality of training iterations.

### RELATED APPLICATIONS

This application claims the benefit of priority from U.S. Provisional Patent Application No. 62/798,578 filed on Jan. 30, 2019, the contents of which are incorporated herein by reference in their entirety.

### TECHNOLOGICAL FIELD

The present invention is in the field of signal reconstruction, and relates to a system and method for compressed signal reconstruction utilizing machine learning models approach, in particular, utilizing artificial neural networking. The invention is particularly useful for light field reconstruction, e.g. light field photography.

### RELATED DOCUMENTS

[1] A. Adler, D. Boublil, and M. Zibulevsky. Block-based compressed sensing of images via deep learning. In IEEE 19^{th} International Workshop on Multimedia Signal Processing (MMSP), pages 1-6, October 2017.
[2] M. Aharon, M. Elad, and A. Bruckstein. rmk-svd: An algorithm for designing overcomplete dictionaries for sparse representation. IEEE Transactions on signal processing, 54(11):4311-4322, 2006.
[3] A. Beck and M. Teboulle. A fast iterative shrinkage-thresholding algorithm for linear inverse problems. SIAM journal on imaging sciences, 2(1):183-202, 2009.
[4] S. Boyd, N. Parikh, E. Chu, B. Peleato, and J. Eckstein. Distributed optimization and statistical learning via the alternating direction method of multipliers. Foundations and Trends R in Machine Learning, 3(1):1-122, 2011.
[5] J. Chen and L.-P. Chau. Light field compressed sensing over a disparity-aware dictionary. IEEE Transactions on Circuits and Systems for Video Technology, 27(4):855-865, 2017.
[6] D.-A. Clevert, T. Unterthiner, and S. Hochreiter. Fast and accurate deep network learning by exponential linear units (elus). Proceedings of the International Conference on Learning Representations (ICLR), 2016.
[7] D. L. Donoho, M. Elad, and V. N. Temlyakov. Stable recovery of sparse overcomplete representations in the presence of noise. IEEE Transactions on information theory, 52(1):6-18, 2006.
[8] J. Flynn, I. Neulander, J. Philbin, and N. Snavely. Deepstereo: Learning to predict new views from the world's imagery. In Proceedings of the IEEE Conference on Computer Vision and Pattern Recognition, pages 5515-5524, 2016.
[9] R. Giryes, Y. C. Eldar, A. M. Bronstein, and G. Sapiro. Tradeoffs between convergence speed and reconstruction accuracy in inverse problems. IEEE Transactions on Signal Processing, 66(7):1676-1690, April 2018.
[10] X. Glorot and Y. Bengio. Understanding the difficulty of training deep feedforward neural networks. In Proceedings of the Thirteenth International Conference on Artificial Intelligence and Statistics, pages 249-256, 2010.
[11] K. Gregor and Y. LeCun.Learning fast approximations of sparse coding. In Proceedings of the 27th International Conference on Machine Learning (ICML-10), pages 399-406, 2010.
[12] M. Gupta, A. Jauhari, K. Kulkarni, S. Jayasuriya, A. Molnar, and P. Turaga. Compressive light field reconstructions using deep learning. In Proceedings of the IEEE Conference on Computer Vision and Pattern Recognition Workshops, pages 11-20, 2017.
[13] Y. Han, J. Yoo, and J. C. Ye. Deep residual learning for compressed sensing ct reconstruction via persistent homology analysis. arXiv preprint arXiv:1611.06391, 2016.
[14] M. Hirsch, S. Sivaramakrishnan, S. Jayasuriya, A. Wang, A. Molnar, R. Raskar, and G.

Wetzstein. A switchable light field camera architecture with angle sensitive pixels and dictionary-based sparse coding. In IEEE International Conference on Computational Photography (ICCP), pages 1-10, 2014.
[15] S. Ioffe and C. Szegedy. Batch normalization: Accelerating deep network training by reducing internal covariate shift. In International Conference on Machine Learning, pages 448-456, 2015.
[16] F. E. Ives. Parallax stereogram and process of making same., Apr. 14 1903. U.S. Pat. No. 725,567.
[17] H.-G. Jeon, J. Park, G. Choe, J. Park, Y. Bok, Y.-W. Tai, and S. Kweon. Accurate depth map estimation from a lenslet light field camera. In The IEEE Conference on Computer Vision and Pattern Recognition (CVPR), June 2015.
[18] N. K. Kalantari, T.-C. Wang, and R. Ramamoorthi. Learning-based view synthesis for light field cameras. ACM Transactions on Graphics (TOG), 35(6):193, 2016.
[19] D. Kingma and J. Ba. Adam: A method for stochastic optimization. Proceedings of the 3rd International Conference on Learning Representations (ICLR), 2015.
[20] A. Krizhevsky, I. Sutskever, and G. E. Hinton. Imagenet classification with deep convolutional neural networks. In Advances in neural information processing systems, pages 1097-1105, 2012.
[21] K. Kulkarni, S. Lohit, P. Turaga, R. Kerviche, and A. Ashok. Reconnet: Non-iterative reconstruction of images from compressively sensed random measurements. IEEE Conference on Computer Vision and Pattern Recognition (CVPR), 2016.
[22] C. Ledig, L. Theis, F. Huszar, J. Caballero, A. Cunningham, A. Acosta, A. Aitken, A. Tejani, J. Totz, Z. Wang, et al. Photo-realistic single image super-resolution using a generative adversarial network. IEEE Conference on Computer Vision and Pattern Recognition (CVPR), 2017.
[23] J. Long, E. Shelhamer, and T. Darrell. Fully convolutional networks for semantic segmentation. In Proceedings of the IEEE Conference on Computer Vision and Pattern Recognition, pages 3431-3440, 2015.
[24] J. Mairal, F. Bach, J. Ponce, and G. Sapiro. Online dictionary learning for sparse coding. In Proceedings of the 26^{th} annual international conference on machine learning, pages 689-696. ACM, 2009.
[25] M. Mardani, E. Gong, J. Y. Cheng, S. Vasanawala, G. Zaharchuk, M. Alley, N. Thakur, S. Han, W. Dally, J. M. Pauly, et al. Deep generative adversarial networks for compressed sensing automates wri. arXiv preprint arXiv:1706.00051, 2017.
[26] K. Marwah, G. Wetzstein, Y. Bando, and R. Raskar. Compressive light field photography using overcomplete dictionaries and optimized projections. ACM Transactions on Graphics (TOG), 32(4):46, 2013.
[27] D. Mendlovic, R. Schleyen, and U. MENDLOVIC. System and method for light-field lmaging, Jul. 13 2017. U.S. patent application Ser. No. 15/321,505.
[28] R. Ng, M. Levoy, M. Bredif, G. Duval, M. Horowitz, and P. Hanrahan. Light field photography with a hand-held plenoptic camera. Computer Science Technical Report CSTR, 2(11):1-11, 2005.
[29] S. F. Ray. Applied photographic optics: Lenses and optical systems for photography, film, video, electronic and digital imaging. Focal Press, 2002.
[30] T. Remez, O. Litany, R. Giryes, and A. M. Bronstein. Deep class-aware image denoising. In IEEE International Conference on Image Processing (ICIP), 2017.
[31] P. Sprechmann, A. M. Bronstein, and G. Sapiro. Learning efficient sparse and low rank models. IEEE transactions on pattern analysis and machine intelligence, 37(9):1821-1833, 2015.
[32] P. P. Srinivasan, T. Wang, A. Sreelal, R. Ramamoorthi, and R. Ng. Learning to synthesize a 4d rgbd light field from a single image. International Conference on Computer Vision (ICCV), 2017.
[33] Stanford. Stanford lytro light field archive. www(dot)lightfields(dot)stanford(dot)edu.
[34] C. Szegedy, W. Liu, Y. Jia, P. Sermanet, S. Reed, D. Anguelov, D. Erhan, V. Vanhoucke, and A. Rabinovich. Going deeper with convolutions. In Proceedings of the IEEE conference on computer vision and pattern recognition, pages 1-9, 2015.
[35] A. K. Vadathya, S. Cholleti, G. Ramajayam, V. Kanchana, and K. Mitra. Learning light field reconstruction from a single coded image. Asian Conference on Pattern Recognition (ACPR), 2017.
[36] A. Veeraraghavan, R. Raskar, A. Agrawal, A. Mohan, and J. Tumblin. Dappled photography: Mask enhanced cameras for heterodyned light fields and coded aperture refocusing. ACM Trans. Graph., 26(3):69, 2007.
[37] G. Wetzstein, I. Ihrke, and W. Heidrich. On plenoptic multiplexing and reconstruction. International journal of computer vision, 101(2):384-400, 2013.
[38] F. Yu and V. Koltun. Multi-scale context aggregation by dilated convolutions. Proceedings of the International Conference on Learning Representations (ICLR), 2016.
[39] M. D. Zeiler, D. Krishnan, G. W. Taylor, and R. Fergus. Deconvolutional networks. In IEEE Conference on Computer Vision and Pattern Recognition (CVPR), pages 2528-2535, 2010.
[40] H. Zhao, O. Gallo, I. Frosio, and J. Kautz. Loss functions for image restoration with neural networks. IEEE Transactions on Computational Imaging, 3(1):47-57, 2017.

Acknowledgement of the above references herein is not to be inferred as meaning that these are in any way relevant to the patentability of the presently disclosed subject matter.

### BACKGROUND

Compressed sensing is a signal processing technique for efficiently acquiring and reconstructing a signal. Mathematically, compressed sensing is denoted as the inverse problem y=ϕx, where y is the measured compressed signal, x is the original signal and ϕ is an over complete (rectangular) sensing matrix, which typically encodes the original signal. In compress sensing theory, various algorithms such as OMP, LARS, ISTA etc., can solve this problem. For high dimensional signals such as images, videos, light fields, these techniques suffer from high computational complexity, which makes it unpractical for real time usage.

Conventional 2D images contain only color information of the primary colors (RGB) content of a given scene, while light field images hold also the angular information of light collected from the scene. This allows performing challenging tasks such as refocusing and depth extraction, which are harder to be done using only the spatial information. The known way of representing light field information is as a collection of 2D images, taken from multi-viewpoints.

Light field images may be captured by various methods such as coded masks, coded apertures, microlenses and pinhole arrays. Due to limited sensor size, these systems suffer from a tradeoff between the spatial and angular resolution that usually results in a sparse number of viewpoints. To address this drawback, bulky imaging systems or array of sensors have been proposed. These solutions are either impractical or expensive and bulky as they require a large amount of storage and have a bigger size.

Recently, the concept of compressive light field photography has been proposed [26], to tackle the trade-offs between the spatial and angular resolutions. It obtains by only one lens, a compressed version of the regular multi-lens system. More specifically, according to this concept, which is based on the compressed sensing theory, a high-resolution light field is reconstructed from its 2D coded projection measured by a single sensor. This approach guarantees under some conditions the recovery of a signal, which has a sparse representation in a given dictionary, from a relatively small number of linear measurements. The technique described in reference [26] utilizes a learned dictionary decomposed of light field atoms. Following this reference, several improvements have been proposed for both the sensing system and the recovery algorithms [5],
[12], [14]. These methods, however, still do not provide for real-time light field acquisition.

Various models, specifically machine learning models such as, for example, neural networks have been also implemented to synthesize new light field views from few given perspectives [18] or even a single view [32]. They have been used also to solve inverse problems with sparsity priors [9], [11], [31] and specifically compressed sensing problems [1], [21]. These methods have shown to produce better and faster results compared to “classic” sparse coding techniques.

### SUMMARY

There is a need in the art for a novel approach for data/signal reconstruction from coded measured image data, which advantageously provides for using a single model for example, a single neural network for handling multiple signal coding functionalities of different types/codings of a physical coding system to simplify the signal reconstruction and minimizing memory usage and computational time. This approach is aimed at solving data/signal reconstruction in various types of sensing systems (e.g. optical, acoustic, electronic sensing systems) of the type receiving an input signal data and generating output coded signal/data, such that the system response function (sensing matrix), describing a relation between the real input and coded output, is defined by coding functionality (e.g. compressed coding functionalities) of the sensing system.

Known algorithms that are based on deep learning (an emerging machine learning field) have shown phenomenal performance in solving compressed sensing tasks with high reconstruction capabilities while sustaining low computational time. However, these solutions address the case of a single sensing matrix (coding functionality) ϕ. In physical compression systems (sensing/imaging systems), the sensing matrix ϕ varies with time, location, spectrum and other parameters. Accordingly, a specific model, e.g., a specific neural network is required for each variation of the sensing matrix ϕ, resulting in a need for a huge number of models (neural networks) and thus very high memory consumption, which also increases significantly the computational time.

As indicated above, standard deep learning methodologies applied on compressed sensing, may require multiple learning models such as the neural networks when the sensing matrix ϕ changes over the compressed signal depending on factors such as time, location, spectrum and others that are common in physical compressive systems. For example, standard FCN (fully convolutional network) for compressed sensing task can weight around 20 MB. Thus, if the training process can endure patches (e.g. pixel segments (subsets)) interchangeably designated segments hereinafter, of up to 100×100 pixels due to memory limitation then a different neural network for each segment (patch) is needed. This implies that for a low-resolution image of 1MP, 2 GB of memory is needed for all the neural networks and that is for a segment by segment (patch-by-patch) solution, which usually provide lower quality results. For a 10MP image with stride of 50 pixels, 800 GB of memory is required. It is clear that it is not practical to perform compressed sensing task without a robust neural network in which 20 MB of memory will be able to solve the entire signal regardless of its size or the changes in ϕ along the compressed signal.

The present invention provides a novel approach for reconstruction of coded signals (e.g. compressed coded signals) using a single trained machine learning model, for example, a single trained deep neural network which is capable of reconstructing signal coded data of multiple types/codings used in a physical coding system. To this end, the present invention provides novel training methodology for training the models, e.g., the neural network for signal reconstruction tasks, which produces a trained deep neural network which is invariant to the sensing matrix (coding functionality) ϕ of the sensing system providing such coded signal that is to reconstructed. Accordingly, this type of model, e.g., neural network may handle multiple variations of the sensing matrix ϕ in the physical encoding system with minimal memory usage and high computational time. Thus, the invention allows implementing deep learning/training based algorithms in real time on compact systems, which usually suffer from low memory capabilities.

The model employed by the present invention may be utilized by each of a plurality of machine learning models, for example, neural networks, deep neural networks, support Vector Machine, decision trees and/or the like. For brevity, the description herein after relates to a deep neural network. This however should not be construed as limiting since as stated, the model may be implemented using one or more other machine learning technologies, methodologies, structures and/or the like.

It should be understood that the coding functionalities of the sensing device are actually described by the sensing matrix ϕ of the device. Such sensing matrix may vary between sensing devices of the similar model/type and/or between different parts of the same signal detection matrix. The present invention provides and utilizes the trained deep neural network that is trained such that it is invariant to such variations, and is capable of receiving as input (either from the sensing device or from an external data storage) the data indicative of the coding functionalities (sensing matrix) and corresponding coded measured data (e.g. compressed coded image) obtained by the sensing device using said coding functionalities and applying inverse problem solution to decode/reconstruct the image.

Thus, according to one broad aspect of the invention, it provides a sensing device comprising: a signal receiver, a sensor unit, and a processing unit connectable to the sensor unit. The signal receiver comprises a signal coder utility configured and operable for receiving/collecting an input signal originated at a signal source (a region/object) of interest and applying coding functionalities to said input signal being received and directing it to the sensor unit, thereby forming on a matrix of sensing elements (e.g. pixels in the case of an image signal) of the sensor unit coded representation of the input signal, and generating coded measured data indicative of said coded representation. The processing unit is configured and operable to receive from the sensor unit the coded measured data and process this to decode the coded representation of the input signal and generate output data indicative of decoded signal to thereby enable to thereby reconstruction of the input signal originated at the region of interest. The processing unit comprises a trained model, specifically a machine learning model such as, for example, a trained deep neural network (TDNN) adapted to decode signals coded by a plurality of different coding functionalities. The different coding functionalities are associated with at least one of the following: coding functionalities of one or more sensing devices of a similar type/model as the sensing device providing said coded measured data; coding functionalities applicable by said signal coder utility on an input signal while being received and directed on different segments (parts/regions) of the matrix of the sensing elements of the sensor unit.

It should be noted that the invention is particularly useful for reconstruction of signals which are compressed and encoded by compressed coding functionalities of a sensing system, such as an imaging system, e.g. light field system. Therefore, the term “coding functionality” or “coding functionalities” should be interpreted broadly covering also compressed coding functionalities.

Further, it should be understood that the (compressed) coding functionalities of the sensing device (e.g. imaging device) are actually described by the sensing matrix ϕ of the sensing device. Such sensing matrix may vary between sensing devices of the similar model/type and/or between different segments (subsets) of the sensing elements (e.g. pixels) of the same matrix (pixel matrix) of the sensor unit. The present invention provides and utilizes the trained model, specifically, the trained deep neural network that is trained such that it is invariant to such variations of the sensing matrix, and is capable of receiving as input (either from the sensing device or from an external data storage) the data indicative of the (compressed) coding functionalities (sensing matrix) and corresponding coded measured data (e.g. compressed coded image) obtained by the sensing device using said coding functionalities and applying inverse problem solution to decode the signal (reconstruct real/input image).

Thus, the technique of the invention provides the neural network which is robust to patterns of codings' functionalities that have the same/similar distribution (behavior). These are patterns associated with the sensing devices of the similar type/model and/or different segments, i.e., different sensing elements subsets of the same sensing device, and are represented by the sensor matrix “describing” the corresponding coding functionalities. Thus, the trained model, e.g., the trained deep neural network is first (previously) trained by sensing matrices that are not identical to the specific sensing matrix ϕ embedding therein (being indicative of) the coding functionalities of the specific sensing device or “related” sensing devices.

The trained model, specifically, the trained deep neural network may be trained in an iterative process comprising a plurality of training iterations in which a plurality of training sets comprising a plurality of real signals each associated with one or more of a plurality of coding functionality patterns (sensing matrices) are fed into the DNN together with a plurality of respective compressed signals each created using a respective one of the real signal applied with a respective one of the sensing matrices.

According to some embodiments of the present invention, the training sets may comprise a plurality of sets associating real signals with one or more sensing matrices employing angular coding, color coding and/or a combination thereof. Moreover, the training sets may comprise a plurality of sets associating a plurality of compressed signals generated for a plurality of different sensing elements segments, for example, different pixel segments in the sensing matrix represented by the real signal, for example, the image represented by the real light signal. Furthermore, the training sets may comprise a plurality of sets associating a plurality of compressed signals generated for a certain elements segment, for example, a certain pixel segment in the sensing matrix represented by the real signal, for example, the image represented by the real light signal which is applied with a plurality of sensing matrices.

The training sets may further comprise a plurality of sets associating a plurality of compressed signals generated for a certain elements segment, for example, a certain pixel segment in the image represented by the real light signal which is applied with a plurality of noise patterns. The training sets may also include a plurality of sets associating a plurality of compressed signals generated for a certain elements segment, for example, a certain pixel segment in the image represented by the real light signal which is applied with a plurality of manufacturing imperfection patterns typical to coders and/or sensors of the sensing devices (imaging devices). Therefore, the manufacturing of a coding sensing system becomes easier, since it does not require high calibration to duplicate the original trained sensing matrix ϕ. Unlike traditional networks that solve compressed sensing tasks, the input of the trained deep neural network of the invention consists of the coded signal and the tensor that represents the coding functionalities. This tensor is a representation of the system's physical compression model. The tensor operation is equivalent to multiplying sensing data of every sensing element associated with a point in the original signal with a fix constant and then summing the relevant dimensions. For example, during the training process, for each patch, i.e., each segment of sensing elements (sensing elements subset), a new ϕ tensor is randomized, but with the same distribution in order to achieve robustness for different ϕ patterns of codings' functionalities. This learning methodology is generic and can be used with almost any deep learning algorithm. Considering imaging applications, the coding functionalities used by the trained deep neural network are associated with compressed coding functionalities of one or more optical assemblies (having the coding utility) of a similar type/model as the optical assembly in the specific imaging device providing the compressed measured data to be decoded. This is a so-called “coding/compressed coding family”. Similarity of optical assemblies of different imaging devices enabling them to be combined by/related to a common compressed coding family is defined by one or more of such parameters of the optical assembly as an effective focal length (defined by a single- or multi-lens focusing optics), and/or F #, and/or feature size of optical coding utilities, as well as the sensor type, and/or one or more filters of similar model/color palette (e.g. RGBW/YCM), and/or illumination intensity (e.g. as consequence of mechanical and/or optical Vignetting effects). The amount of data needed at the input to the trained deep neural network is defined solely by a predetermined size of the pixels in the pixel matrix and that of a function (sensing matrix) describing the compressed coding functionalities, and this is sufficient for the neural network to provide output data defined by the predetermined size of the pixels in the pixel matrix. Alternatively or additionally, as described above, the compressed coding functionalities may be associated with the compressed coding functionalities applicable by the optical assembly on the input light while being received and directed (collected and projected) on different pixel segments (subsets) of the pixel matrix of the sensor unit. In this case, compressed coding data used by the neural network may include data indicative of at least coding functionalities corresponding to at least one of the coded measured data pieces obtained from the respective at least one pixel segment (subset).

To this end, the different pixel segments (subsets) of the pixel matrix are members of the respective “coding/compressed coding family”, meaning that the optical assembly is configured such that there is a certain relation between the optical coding applied to input light projections on different pixel segments (subsets); e.g. the different pixel segments (subsets) provide coded measured data pieces corresponding to the compressed coding functionalities of the same type/model but different in relation to such factors/effects as randomness/order of coding units of the optical coder. In such case, the amount of data needed to be input to the trained deep neural network is defined solely by a predetermined size of the at least one pixel segment (subset) of the pixel matrix and dimensions of a function describing the respective compressed coding functionalities; and the network's output data is defined by the predetermined size of the at least one segment (subset) of pixels.

It should thus be understood that with the trained deep neural network of the present invention, the amount of data to be input to this neural network is, in some embodiments, reduced to data defined by a predetermined size of the sensing elements in the sensing matrix and dimensions of a function describing the respective coding functionalities, and amount of the output data is reduced to data defined by said predetermined size of the sensing elements in the sensing matrix. In some other embodiments, the amount of data to be input to the trained deep neural network is reduced to data defined by a predetermined size of one or more segments, i.e., subsets of the sensing elements of the sensing elements' matrix and dimensions of a function describing the respective coding functionalities; and amount of the output data is reduced to data defined by the predetermined size of said one or more segments (subsets of sensing elements).

The sensing device may be an imaging device. In this case, the signal receiver is configured as an imager comprising an optical assembly and the sensor unit, where the optical assembly comprises an optical coder configured and operable for collecting input light signal arriving from a scene in the region of interest being imaged and applying the compressed coding functionalities to the input light being collected and projected on a pixel matrix of the sensor unit.

Thus, according to another broad aspect of the invention, it provides an imaging device comprising:

An imager comprising a sensor unit and an optical assembly, said optical assembly comprising an optical coder configured and operable for collecting input light arriving from a scene being imaged and applying compressed coding functionalities to said input light being collected and projected on a pixel matrix of the sensor unit, thereby forming on said pixel matrix a compressed image indicative of said input light collected from the scene, and generating compressed measured data indicative of said compressed image; and

A processing unit connectable to said sensor unit, said processing unit being configured and operable to receive from the sensor unit the compressed measured data and process the compressed measured data to decompress said compressed image and generate output data indicative of decompressed image data of the scene, enabling reconstruction of the input light; wherein:

Said processing unit comprises a trained deep neural network adapted to decompress compressed images coded by a plurality of different compressed coding functionalities, associated with at least one of the following: compressed coding functionalities of one or more optical assemblies of a similar type/model as said optical assembly; compressed coding functionalities applicable by said optical assembly on an input light while being collected and projected on different segments (subsets) of the pixel matrix of the sensor unit;

Said trained deep neural network of the processing unit is adapted to receive, as an input, at least a part of the compressed measured data generated by at least a segment (subset) of pixels of the pixel matrix and data indicative of the respective compressed coding functionalities, and decompress a corresponding at least part of the compressed image to thereby generate output data indicative of reconstruction of at least a portion of the input light.

Preferably, the optical coder is configured to apply the compressed coding functionalities (sensing matrices) to the input light such that the coded measured data is indicative of the image thereof compressed in a predetermined multi-dimensional parametric space. In some embodiments, the optical coder is configured to apply different compressed coding functionalities to different parts of the input light being projected on different segments (subsets) of pixels of the pixel matrix.

For example, the compressed coding functionalities (sensing matrices) comprise at least one of the following: angular coding of the input light being projected on the pixel matrix; and color coding of the input light being projected on the pixel matrix. Accordingly, the coded measured data is indicative of an image of the input light compressed in at least one of spectral and angular parametric space.

In case of different compressed coding functionalities applied to different parts of the input light associated with different segments (subsets) of pixels of the pixel matrix, such different compressed coding functionalities may include at least one of angular coding and color coding being different for different parts of the input light projected on the different segments (subsets) of pixels of the pixel matrix. More specifically, the optical coder may comprise at least one coded mask located in an optical path of the input light being collected and configured to apply at least one of angular and color encoding to each of u parts of the input light associated with u different locations of the scene, respectively, being collected and projected on the different segments (subsets) of pixels of the pixel matrix of said sensor unit. Preferably, the optical coder comprises a first coded mask that applies applying angular coding to u parts of the input light associated with u different locations of the scene, respectively, thereby producing u respective angular coded light components; and a second coded color mask located downstream of the first coded mask (with respect to direction of input light towards the sensor) and configured to apply color coding to the angularly coded light components being projected on the different segments (subsets) of the pixels of the pixel matrix.

With the above configuration of the optical coder, the sensor unit may comprise a monochromatic pixel matrix.

Preferably, the coded color mask is a random mask.

Considering the segments (subsets) of pixels, the segment (subset) may include one or a group of pixels of the pixel matrix.

It should be understood that the angular coding includes separating the input light being collected into an array of u angular light components corresponding to u different discrete locations of the scene and projecting all of the u angular light components onto each segments (subset) (single- or multi-pixel segment (subset)) thereby causing in-pixel summation of the u angular light components on the pixel matrix of the sensor unit with a certain intensity profile.

According to another broad aspect, the invention provides a light field imaging system comprising the above-described imaging device, in which the input signal is a light field coming from the scene being imaged.

According to yet another broad aspect, the invention provides a neural network training system, comprising a processing unit in data communication with a memory utility storing a reference data comprising a plurality of reference data sets, wherein each reference data set comprises:
A coded data piece indicative of at least one segment (part) of an input signal coded by certain coding functionalities in a signal coding utility and detected by at least one segment (subset) of sensing elements of a sensing elements' matrix of a sensor unit;
Said certain coding functionalities that are being applied to said at least a part of the input signal to form said coded data piece;
Un-compressed data piece indicative of said at least a part of input signal;

Whereby the coding functionalities in the reference data sets are associated with at least one of the following:
Coding functionalities of one or more signal coding utilities of a similar type/model;
Compressed coding functionalities applied by said signal coding utility on signal components detected by different segments (subsets) of the sensing elements;

The processing unit comprises a training module configured and operable for receiving said reference data sets and for training a deep neural network based on said reference data sets to obtain a trained deep neural network; said training module being configured and operable for training said deep neural network by carrying out an iterative training mode comprising the following:
providing the coded data piece and the coding functionalities of each reference data set of a plurality of said reference data sets to said deep neural network as an input;
operating said deep neural network to produce an estimated decoded data piece;

performing an iterative mode fitting procedure between the estimated decoded data piece with the un-coded data piece corresponding thereto in said reference data set and correcting parameters of said deep neural network until a best fit condition is reached, thereby obtaining said trained deep neural network.

The so-produced trained deep neural network based on the reference data sets is capable of (a) receiving input data including: (i) a compressed image data piece indicative of a compressed projection of at least a part of input light field on at least one segment (subset) of pixels, and (ii) said certain compressed coding functionalities; and (b) decompressing said compressed image data piece to generate output data indicative of a decompressed image data piece corresponding to said at least a part of input light field.

The deep neural network may be a fully convolutional network (FCN), e.g. the FCN is linked to an unsupervised-trained depth estimation network to thereby directly extract depth map data from the measured compressed image data pieces.

The present invention in its further aspect provides a computer readable medium comprising computer readable code implementing a trained deep neural network capable of carrying out the following: (a) in response to receipt of input data indicative of a request for decoding of a coded data indicative of a collected input signal being coded by a signal coding utility in a sensing device having a matrix of sensing elements, decoding said coded data, by utilizing data indicative of reference data sets comprising at least one of the following: (i) certain coding functionalities associated with a signal coding utility of similar type/model or associated with a coding functionalities applied by said signal coding utility to said input signal, and (ii) coding functionality of said coding utility applied to said input signal; and (b) generating output data indicative of the decoded data.

It should be understood that the trained deep neural network may be part of the sensing/imaging system/device or a separate computing system, e.g. server system connected to a communication network. The data indicative of the compressed coding functionalities of the imaging system may be produced once (by the above-described training procedure) and then used many with multiple “matching” coded measured data pieces. Hence, the data indicative of the compressed coding functionalities of the imaging system, being the imaging system relating data (a so-called “digital certificate of the sensing/imaging system”), may be stored in a separate storage system and accessed and associated with each coded measured data piece to be input together to the trained deep neural network.

For example, a communication system comprising the trained deep neural network is configured for data communication with the imaging system/device to receive therefrom the coded measured data piece and associating the coded measured data with the matching data comprising compressed coding functionalities characterizing said sensing system (e.g. accessed from a memory of the sensing system or a separate (remote) storage system).

Thus, according to some aspects of the invention, it provides a sensing/imaging system/device, which is associated with the trained deep neural network (e.g. is in data communication with the a server/cloud site comprising such neural network; or including such neural network as its constructional part), and which is associated with a storage utility (e.g. connectable to an external storage, or using its internal storage) where the data indicative of the compressed coding functionalities of the sensing system previously determined is stored. Hence, the coded measured data being sensed by the imaging system inputs the trained deep neural network together with the matching compressed coding functionalities.

For example, the invention can be incorporated in a personal communication device having a camera, e.g. phone device, where the trained deep neural network is installed, and the compressed coding functionalities of the camera are stored in the device memory. The camera's output, being the coded measured data (compressed encoded measured data, e.g. compressed measured light field) is input to the trained deep neural network, which utilizes the pre-stored compressed coding functionalities to process the coded measured data and reconstruct the original image(s).

The invention also provides a server system connected to a communication network and configured for data communication with a plurality of sensing systems via said communication network, the server system comprising: a processing unit comprising a trained deep neural network configured and operable to receive from at least one sensing system coded measured data comprising coded measured signal corresponding to a coding applied to input signal according to certain coding functionalities of the respective sensing system; and analyze the received coded measured data utilizing predetermined data indicative of the certain coding functionalities, to decode the coded signal to thereby generate output data indicative of reconstruction of the input signal.

The data indicative of the certain compressed coding functionalities may be provided by the imaging system itself, or may be obtained from an external database to which the server system has access. As described above, the compressed coding functionalities are associated with at least one of the following: compressed coding functionalities of one or more imaging systems of a similar type/model as said imaging system providing the coded measured data; compressed coding functionalities applicable by said imaging system on input light field while being collected and projected on different segments (subsets) of the pixel matrix of the imaging system.

The data indicative of the certain compressed coding functionalities may include a multi-dimensional function describing the compressed coding functionalities, i.e. the sensing matrix; or identification data of the specific imaging system, thereby enabling to obtain from a database a corresponding multi-dimensional function describing the compressed coding functionalities for reconstructing the input light.

The present invention is more specifically useful for light field photography and is therefore described below with respect to this specific application. It should, however, be noted that the principles of this invention are not limited to this specific application, and the invention can be used for any signal reconstruction from coded measured representation thereof generated by a sensing/imaging system having characterizing compressed coding functionalities.

For light field photography the sensing elements are simply pixels representing a scene of a region of interest captured by an imaging sensor. The term pixels(s) may be therefore used herein after to replace the term sensing element(s).

Light field photography has been studied thoroughly in recent years. One of its drawbacks is the need for multi-lens in the imaging. To compensate that, compressed light field photography has been proposed to tackle the trade-offs between the spatial and angular resolutions. It obtains by only one lens, a compressed version of the regular multi-lens system. The acquisition system consists of a dedicated hardware followed by a decompression algorithm, which usually suffers from high computational time.

The present invention utilizes a computationally efficient neural network that recovers a high-quality color light field from a single coded image. According to some aspects of the technique of the invention, the optical assemble (imaging device) is configured such that color channels are compressed as well, thereby eliminating the need for a CFA in the sensor unit of the imaging system. The invention provides for outperforming existing solutions in terms of recovery quality and computational complexity. The invention provides a novel trained deep neural network capable of depth map extraction based on the decompression of the light field. The neural network can be trained in an unsupervised manner without the ground truth depth map.

The single trained deep neural network may concurrently perform decompression of the coded measured data pieces of the multiple types of compressed codings, thereby enabling decompression of the input light projected at various places on the imaging sensor, thereby eliminating a need for multiple neural networks.

As indicated above, such single trained deep neural network may utilize a fully convolutional network (FCN), where the FCN may be linked to an unsupervised-trained depth estimation network, to directly extract depth map data from the coded measured light field data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of non-limiting example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be carried out in practice.

In the drawings:

FIG. 1 is a block diagram of a sensing system according to some embodiments of the invention;

FIG. 2 more specifically illustrates the technique of the invention for coding (compressing and encoding) and reconstructing coded signal/data in the sensing system applying coding functionalities to input signal being received and sensed and a robust trained deep neural network performing signal decoding;

FIG. 3A, FIG. 3B, FIG. 3C and FIG. 3D schematically illustrate four examples, respectively, of the configurations of the sensing system of the invention;

FIG. 4 is a block diagram of an example of the imaging device of the invention configured to apply the compressed coding functionalities to the input light field to produce coded measured data in a predetermined spectro-angular parametric space;

FIG. 5A and FIG. 5B demonstrate the principles of the single compression and coding performed by an angular coder, and combination of angular and color coders of the system of FIG. 4;

FIG. 6 shows schematically the imaging system of the invention utilizing the imaging device in which different pixel segments (subsets) provide coded measured data pieces corresponding to the compressed coding functionalities (sensing matrices) of the same type/model but different in relation to such factors/effects as randomness/order of coding units of the optical coder;

FIG. 7 illustrates schematically the principles of the training procedure applied to train a model, in particular a machine learning model such as, for example, a deep neural network (DNN) to create a TDNN of the present invention;

FIG. 8 demonstrates reconstruction of a color light field image from a 2D coded image projected at the sensor in a single shot;

FIG. 9A and FIG. 9B exemplify the diagonal sensing matrix and corresponding tensor representing the sensing matrix;

FIG. 10A, FIG. 10B and FIG. 10C show 20×20 examples of the generated masks for, respectively, uniform distribution, RGB distribution, and RGBW distribution. exemplifies the reconstruction network of the present invention, formed of 11 3×3 convolutional layers with 128 channels, using the tensor of FIG. 5B as a part of the data input;

FIG. 11 exemplifies the reconstruction network of the invention consisting of 11 3×3 convolutional layers with 128 channels; and

FIG. 12, FIG. 13, FIG. 14, FIG. 15, FIG. 16, FIG. 17, FIG. 18, FIG. 19 and FIG. 20 illustrate various simulation and experimental results demonstrating features of the technique of the invention, and advantages as compared to the various other known techniques.

### DETAILED DESCRIPTION

As indicated above, the present invention provides a novel technique for reconstruction of an original signal/data originated at a signal source (e.g. region/object of interest) from coded (e.g. compressed and encoded) measured data indicative thereof obtained by a sensing device having coding functionalities. In various configurations, the present technique provides advantageous decompression performance as compared to the known techniques in terms of reduced amount of data needed for decoding and reconstruction and relatively low computational time.

To this end, the invention provides for use of a single model, specifically, a single machine learning model, for example, a single deep neural network (DNN) appropriately trained according to the invention to decode coded measured data coded by multiple types of sensing matrices/coding functionalities, such that the trained deep neural network TDNN is invariant to variation between the different coding functionalities.

For brevity, the model, i.e. the machine learning model described herein after relates to a deep neural network. However, as stated herein before, this should not be construed as limiting since the model may be implemented using one or more other machine learning technologies, methodologies, structures and/or the like.

Thus, the present invention is some embodiments provides a novel sensing (e.g. imaging) device/system which includes the trained model, i.e. the trained deep neural network (TDNN) as a part thereof; and/or is configured for communication with such TDNN installed in a remote computer (e.g. server system to which the sensing device has access). As will be described more specifically further below, the technique of the present invention enables to significantly reduce the input to the TDNN and the output thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

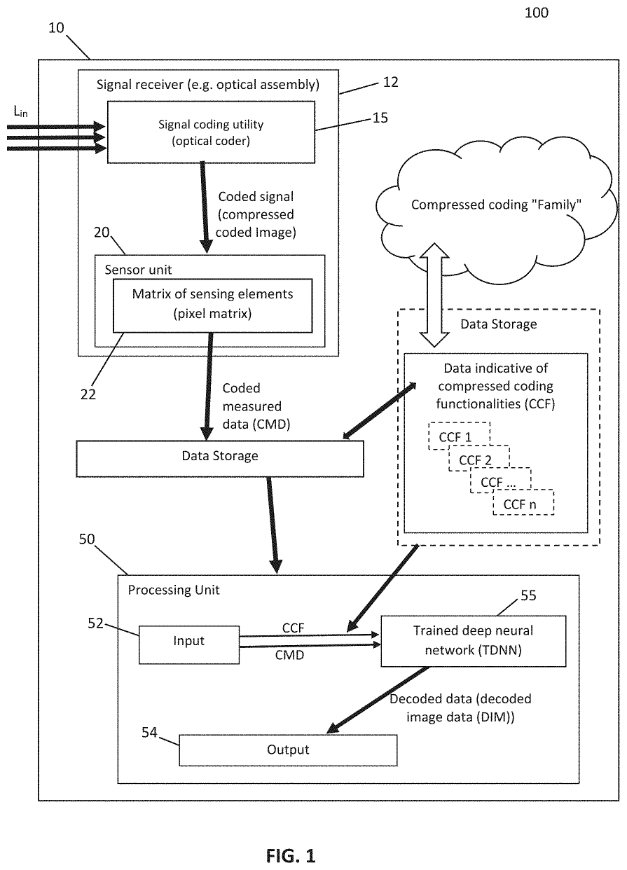

Reference is made to FIG. 1 schematically illustrating, by way of a block diagram, a sensing system 100 according to some embodiments of the invention. In this specific not limiting example the sensing system is illustrated as an imaging system. It should, however, be understood that the principles of the present invention are not limited to this specific example, and can be used for coded data/signal reconstruction in/with any sensing system of the type receiving an input signal data and generating output coded signal/data, in accordance with the system response function (describing a relation between the real input and coded output) defined by coding functionality (sensing matrix) of the sensing system.

The imaging system 100 includes an imaging device 10 (sensing device) including an optical assembly 12 (a signal receiver assembly) which includes an optical coder 15 (signal coding utility) and a sensor unit 20, and is associated with a processing unit/utility 50 which includes a trained deep neural network (TDNN) 55. The processing unit with the TDNN may be an integral part of the imaging device 10, e.g. being installed in the processing unit of the imaging device or a separate processor installed in the imaging device; or may be installed in a stand-alone system (remote system) connectable to/accessible by the imaging device 10 via any type of known suitable communication networks/protocols.

The optical assembly 12 is configured for collecting input light Lᵢₙ from a scene (region of interest) and projecting the collected light onto a pixel matrix 22 of the sensor unit 20 to image the input light on the sensor unit. The optical assembly 12 includes the optical coder 15 configured to apply compressed coding functionalities on the light being collected and projected on the pixel matrix 22, such that a compressed image is created on the pixel matrix 22, which generates corresponding compressed measured data CMD indicative of the compressed image.

The processing utility 50 is configured generally as a computer unit/circuit including inter alia such utilities as data input and output 52 and 54, and memory 56, and, as indicated above, includes (is installed with) the TDNN 55 configured and operable according to the present invention. The processing unit 50 receives from the sensor unit 20 the compressed measured data CMD and operates to process the compressed measured data CMD to decompress the corresponding compressed image and generate output data indicative of decompressed image data DIM of the scene, which corresponds to/enables to obtain reconstruction of the input light.

More specifically, the TDNN 55 receives the input compressed measured data CMD and utilizes previously provided (determined during the training procedure, as will be described further below, and stored in a data storage) data indicative of compressed coding functionalities CCF corresponding to the creation of the compressed measured data and operates to decompress the compressed image. The previously determined compressed coding functionalities may be stored in the memory 56 of the imaging device 10, or may be obtained from an external storage device to which the imaging device has access via suitable data communication utilities/protocols.

In some embodiments, the previously determined and stored compressed coding functionalities CCF are associated with compressed coding functionalities of one or more optical assemblies of a similar type/model as the optical assembly 12, i.e. a so-called “compressed coding family”. As indicated above, the optical assembly 12 is configured to provide compressed measured data indicative of an image of the input light Lᵢₙ. Similarity of optical assemblies of different imaging devices enabling them to be combined by/related to a common compressed coding family is defined by one or more of such parameters of the optical assembly as an effective focal length (defined by a single- or multi-lens focusing optics), and/or F #, and/or feature size of optical coding utilities, as well as the sensor type, and/or one or more filters of similar model/color palette (e.g. RGBW/YCM), and/or illumination intensity (e.g. as consequence of mechanical and/or optical Vignetting effects). The amount of data needed at the input to the TDNN 55 is defined solely by a predetermined size of the pixels in the pixel matrix 22 and that of a function (sensing matrix) describing the pre-stored compressed coding functionalities, and this is sufficient for the TDNN 55 to provide output data defined by the predetermined size of the pixels in the pixel matrix.

Alternatively or additionally, the previously determined and stored compressed coding functionalities are associated with the compressed coding functionalities applicable by the optical assembly 12 on the input light Lᵢₙ while being collected and projected on different pixel segments (subsets) of the pixel matrix of the sensor unit. For example, as shown in the figure in dashed lines, the previously determined and stored data may include data indicative of at least one of n compressed coding functionalities CCF₁, CCF₂, . . . , CCFₙ corresponding to at least one the compressed measured data pieces obtained from the respective at least one pixel segment (subset) from n pixel segments (subsets) PS₁, PS₂, . . . , PSₙ. This can be used for the case where the optical assembly is configured such that there is a certain relation between the optical coding applied to input light projections on different pixel segments (subsets); e.g. the different pixel segments (subsets) provide compressed measured data pieces corresponding to the compressed coding functionalities of the same type/model but different in relation to such factors/effects as randomness/order of coding units of the optical coder. This will be described and exemplified more specifically further below. In such case, the amount of data needed to be input to the TDNN 55 is defined solely by a predetermined size of the at least one pixel segment (subset) of the pixel matrix and dimensions of a function describing the respective compressed coding functionalities; and the TDNN's output data is defined by the predetermined size of the at least one segment (subset) of pixels.

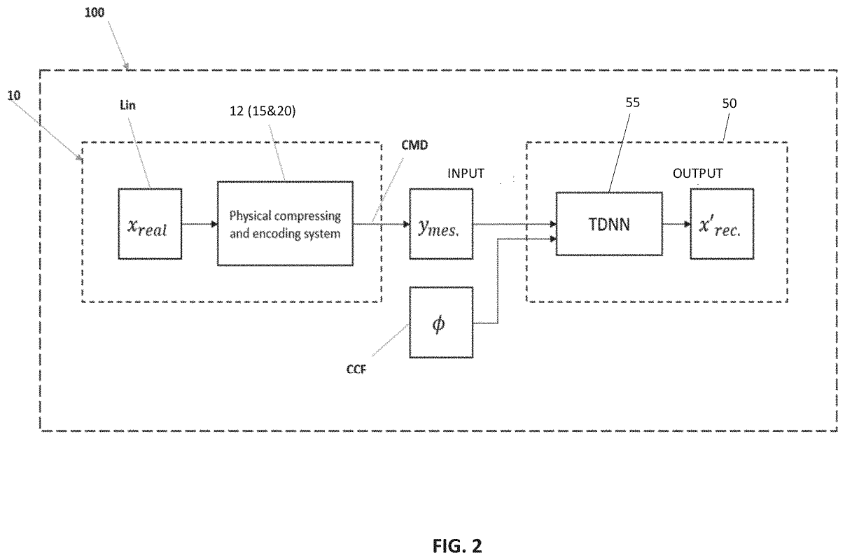

FIG. 2 more specifically illustrates the technique of the invention for compressing and reconstructing signal/data in a sensing (e.g. imaging) system of the kind described above, i.e. utilizing coding of the input signal being received by applying thereto coding functionalities and the robust trained deep neural network performing signal decoding (image decompression), while being invariant to variation of the sensing matrix ϕ associated with different coding functionalities. The figure shows functional units/modules of such sensing system. As shown, input signal (e.g. light signal Lᵢₙ), indicative of a real signal/image xᵣₑₐₗ is collected by the signal receiver (optical assembly), operating as a physical coding (e.g. compressing and encoding) system, which produces coded measured data CMD indicative of a coded signal (compressed coded image) yₘₑₐₛ. The latter, together with the sensing matrix ϕ corresponding to the coding functionalities of the signal receiver (optical assembly) 12 are input to the TDNN 55, which decodes the signal (decompresses the image) and outputs data x′_{rec} indicative of reconstruction of the original real signal xᵣₑₐₗ.

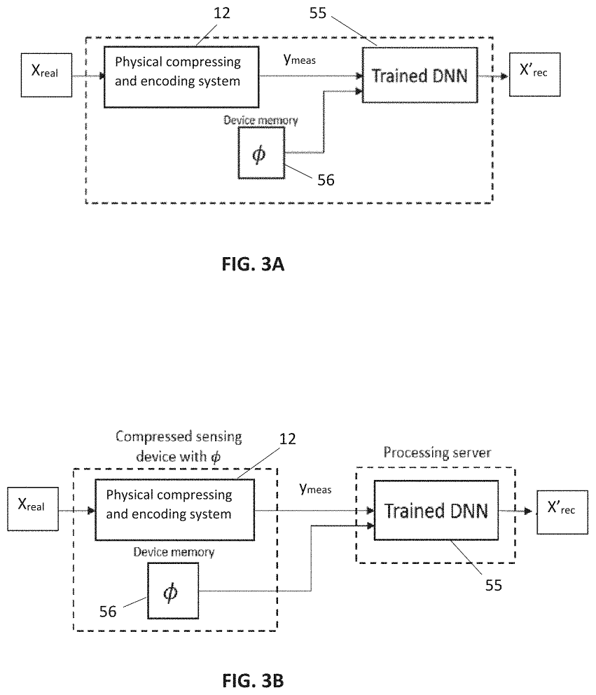

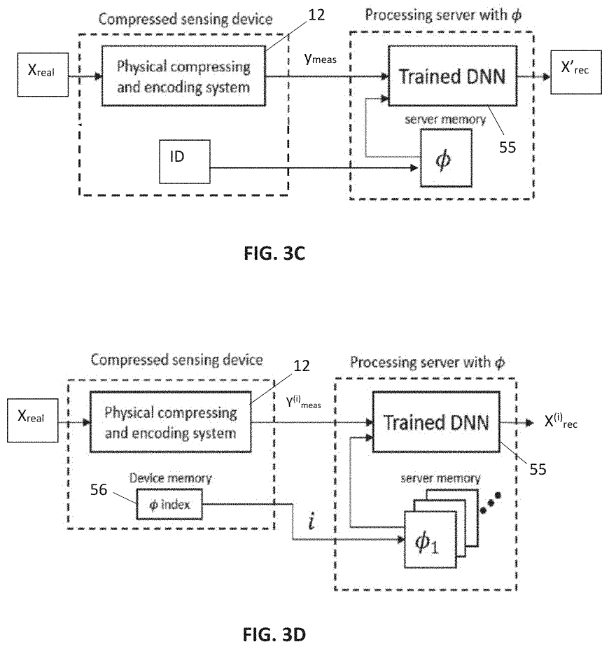

As described above, the processing utility 50 with the TDNN 55 may be part of the sensing device or may be associated with an external system, e.g. server system. This is exemplified in a self-explanatory manner in FIG. 3A, FIG. 3B, FIG. 3C and FIG. 3D, which exemplify the imaging system configurations.

FIG. 3A shows an example of a single device including compressed sensing and decompression processing functionalities, including also storage and supply of the sensing matrix data to the TDNN for the decompression processing. In the example of FIG. 3B, the compressed sensing and storage/provision of the sensing matrix is implemented at a separate imaging device, while the TDNN is installed at a remote server system, which receives the compressed image and the sensing matrix from the imaging device and performs decompression processing. FIG. 3C exemplifies the configuration where the data indicative of the compressed coding functionalities (sensing matrix), matching the received compressed image, is stored at the server system or at a separate database accessible by the server system, and input together with the compressed image to the TDNN. To this end, the imaging device communicates to the server system the compressed image data and also predetermined and pre-stored identification data ID of the respective imaging device, to enable the server system to identify and use the matching sensing matrix. FIG. 3D exemplifies the case where the compressed coding functionalities of the imaging device (optical assembly) include different parts (different sensing matrices) associated with different pixel segments (subsets) of the sensor unit. Accordingly, the respective data indicative of the compressed coding functionalities includes the index (some matching data) indicative of the match between the compressed measured data piece and the part of the compressed coding functionalities.

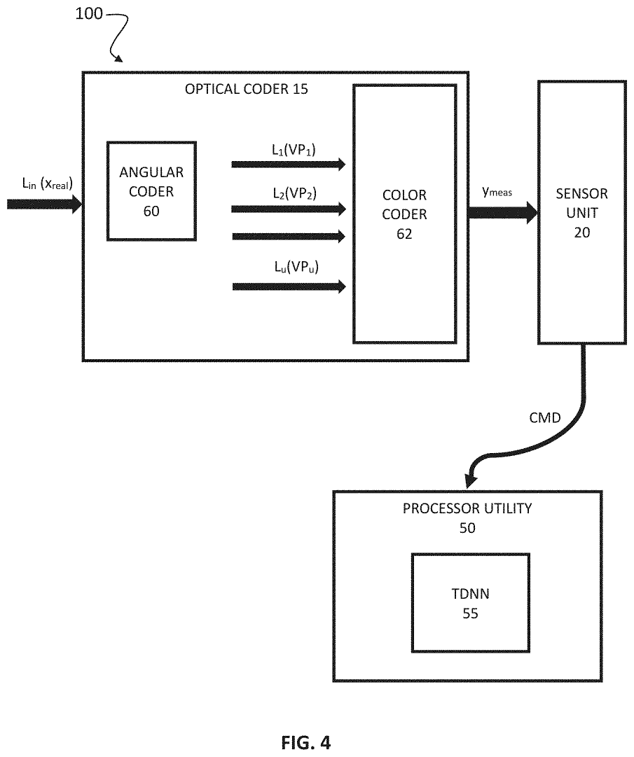

As mentioned above, the present invention is demonstrated for light field photography but may be also applicable for other applications. In this connection, reference is made to FIG. 4 exemplifying the principles of the configuration and operation of the light field imaging system using the present invention. To facilitate understanding, the same reference numbers are used for identifying the elements/utilities common in all the examples of the invention. The light field imaging device 10 is configured to apply the compressed coding functionalities to the input light field such that the compressed measured data is indicative of the image thereof compressed in a predetermined multi-dimensional parametric space. As such the input signal, for example, the input light field may be coded by representation in the predetermined multi-dimensional parametric space.

Moreover, the compression and coding is such that different compressed coding functionalities (sensing matrices) are applied to different parts of the input light field being projected on different segments (subsets) of pixels of the pixel matrix.

As shown, the imaging device 10 includes an optical assembly 12 including an optical coder 15 and sensor unit 20 having a pixel matrix. The sensor unit 20 may be in signal communication with a data processor module/circuit 50 in which the TDNN 55 is installed. The optical coder 15 includes an angular coder 60 and a color coder 62. The angular coder 60 is configured to apply image compression on the input light and the color coder 62 applies further coding to the so-compressed data.

The optical assembly 10 is configured for collecting input light field Lᵢₙ from a scene (indicative of a real image xᵣₑₐₗ), creating output light Lout indicative of projection of the collected input light field onto the pixel matrix of the sensor 20 which may be monochromatic. Compressed measured data CMD indicative of the compressed coded image yₘₑₐₛ generated by the sensor unit 20, together with the predetermined sensing matrix (compressed coding functionalities defined by the optical processing applied by the optical and color coding) then undergoes post-processing by the TDNN 55. It should be noted, although not specifically shown that the optical assembly may include one or more light directing elements, e.g. one or more lenses.

The angular coder 60 is configured to apply angular coding (spatial compression) to the collected input light field Lᵢₙ to thereby produce angularly coded light in the form of a plurality/array of angular light components corresponding to projections of the respective plurality of different discrete viewpoints of the scene onto the pixel matrix of the sensor unit. More specifically, the angular coder 104 separates the input light field Lᵢₙ being collected into u angular light components, L₁(VP₁), L₂(VP₂), . . . , Lᵤ(VPᵤ), corresponding to u different discrete viewpoints VP₁, VP₂, . . . , VPᵤ of the scene, and projects all these viewpoints onto each pixel of the pixel matrix (or each pixels of at least some/sub-set/group of the pixel matrix) of the sensor unit 20, thereby causing in-pixel or within-pixel summation of these u light components on the pixel matrix. Generally, the angular coder 60 includes an array of spaced-apart optical windows arranged in one- or two-dimensional array (apertures and/or microlenses).

These angular separated light components, on their way to the sensor unit, interact with the color coder (filter) 62. As will be described more specifically further below, the color coder 62 may include filter elements from at least two groups, where each group has different light transmission spectrum, with a predetermined spatial arrangement/pattern of the filter elements. As also will be described more specifically further below, the color coder 62 located in the optical path of the angularly coded light components propagating to the pixel matrix codes every viewpoint differently, while not affecting the propagation/projection of the separated light components to allow every pixel in the sensor (or at least in a pixel segment (subset) of the pixel matrix) to receive the light from all the viewpoints (with different intensity and\or wavelength). The filter 62 is located downstream of the apertures 60 with respect to a general propagation direction of light through the optical assembly 12 at a certain distance from the pixel matrix of the sensor unit 20, enabling to apply different color coding to different angular components interacting with the same pixel segment (subset). The filter 62 may be polychromatic, and as indicated above may have a pattern formed by a predetermined arrangement of filter elements/cells comprising the elements of two or more groups. The two or more groups of the filter elements have preferred transmission in, respectively, two or more different wavelength ranges. In some embodiments, one of the wavelength ranges corresponds to white color (i.e. respective filter elements are transparent to the whole visible spectrum). The shape of each aperture is not limited, and the apertures in the array may be of any shape/geometry, as well as may be of the same or different shapes. Different aperture shapes could be used for various light field applications. Also, the number of apertures may change for various applications.

Thus, the angular coder 15 applies angular separation (coding) of the collected light, and projects the angular components onto the sensing plane such that each pixel of at least one pixel segment (subset) receives a light portion including all the angular components. The color filter 62 applies slightly different color coding to each angular component of the so-produced angularly separated light. As a result, light yₘₑₐₛ reaching the detector unit 20 presents an image of the input light field Lᵢₙ in a spectro-angular parametric space. The combination of the angular and color coders arranged in a spaced apart relationship along the optical axis and at some distance from the pixel matrix provides that the compressed coding functionalities associated with different pixel segments (subsets) have some similarities between them, in the sense for example that light from the i-th view point that falls on the j-th pixel segment (subset) experiences the similar color coding as light from k-th view point that falls on m-th pixel segment (subset). In other words, the compressed functionalities (e.g. matrices) associated with the pixel segments (subsets) have some degree of pattern repetition. This facilitates the use of the single and compact neural network (being previously appropriately trained) to apply decompression to the compressed measured data pieces from different segments (subsets) which have been compressed by such different compressed coding functionalities. Examples of the configuration and operation of the imaging device of FIG. 4 are described in a co-pending IL patent application No. 257635, assigned to the assignee of the present application, which patent application is incorporated herein by reference with respect to this specific not limiting example of the present invention.

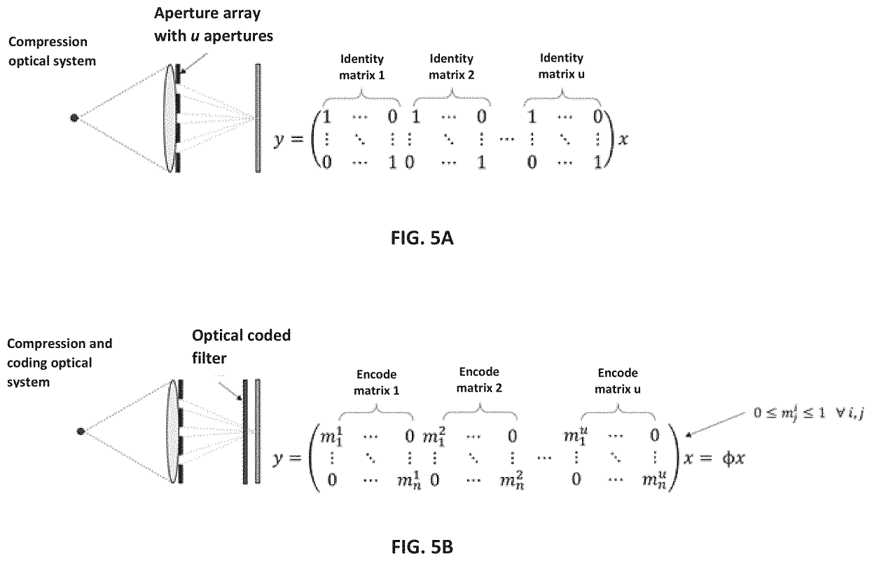

As shown in FIG. 5A, with the optical assembly schematically shown in FIG. 4, including only the angular coder 60 and no color coder, the summation of the different angular light components intensities (corresponding to the different viewpoints) on the pixel matrix can mathematically be represented by:

$${y}_{n \times 1} = {ϕ}_{n \times {m}^{x} m \times 1} + N , n < m$$

$$ϕ = \frac{n}{m} \begin{matrix}[ \begin{matrix}1 & 0 & … & 0 \\ 0 & 1 & … & 0 \\ ⋮ & ⋮ & & ⋮ \\ 0 & 0 & … & 1\end{matrix} & … & \begin{matrix}1 & 0 & … & 0 \\ 0 & 1 & … & 0 \\ ⋮ & ⋮ & ⋱ & ⋮ \\ 0 & 0 & … & 1\end{matrix} ]\end{matrix}$$

where y is a column stack (vector) representation of the pixels' measurement by detector (having n pixels arranged in 2D array), x is a column stack LF projected on the n detector pixels from a finite number of apertures u, so that m=n×u, ϕ is the sensing matrix, which compresses (sums and normalize) all the projections from each aperture to one detector pixels, N is noise, n is the number of pixels in the matrix, and m is the number of projection points (i.e. number of apertures/optical window u multiplied by n). The above equation is an overcomplete problem, and in order to solve this type of problem, the color coder 62 is used. This is illustrated in FIG. 5B. Here, n is the number of “image” pixels providing data from the particular angle/view point (considering the polychromatic filter, n is the total number of image pixels of all the color channels for said view point); u is the number of viewpoints (apertures); and mⁱⱼ represents the intensity and/or chromatic filtration applied to light from the i-th viewpoint that falls on the j-th pixel of the sensor.

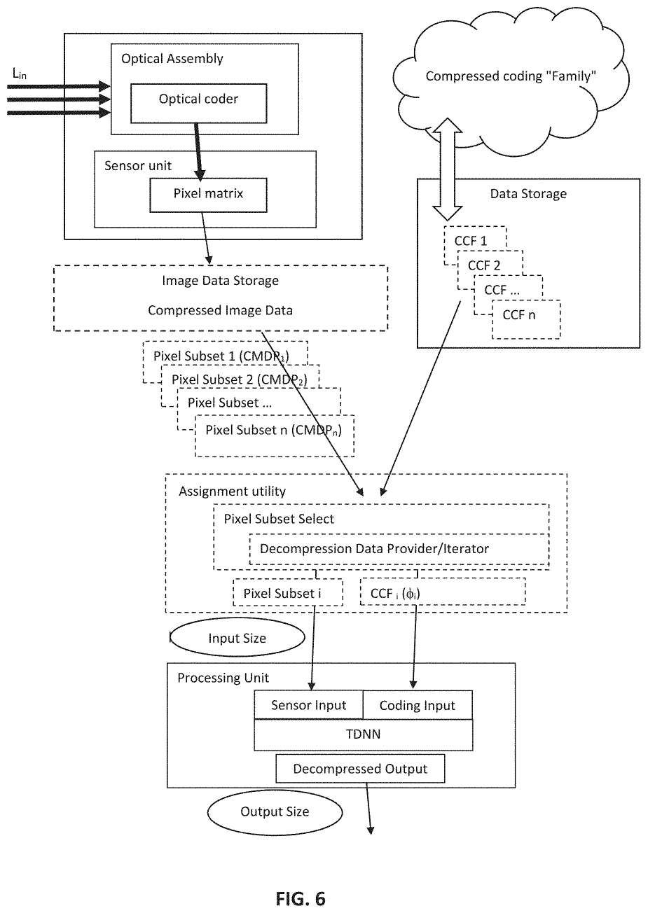

Reference is now made to FIG. 6 schematically illustrating, by way of a block diagram, the imaging system 100 of the invention (constituting the sensing system) utilizing the imaging device, e.g. similar to that exemplified above with reference to FIG. 4, but where the imaging device is configured such that there is a certain relation between the optical coding applied to input light projections on different pixel segments (subsets); e.g. the different pixel segments (subsets) provide compressed measured data pieces corresponding to the compressed coding functionalities (sensing matrices) of the same type/model but different in relation to such factors/effects as randomness/order of coding units of the optical coder. Thus, in this embodiment, the coding family is constituted by different pixel segments (subsets) of the pixel matrix of the sensor unit.

Thus, the system 100 of FIG. 6 is configured similar to that of FIG. 1, for a specific not limiting example where the sensing device 10 is an imaging device, but where the coded measured data CDM includes compressed measured data pieces CMDP₁, CMDP₂, . . . , CMDPₙ corresponding to the compressed coded images detected by respective n pixel segments (subsets) PS₁, PS₂, . . . , PSₙ of the pixel matrix. The corresponding data indicative of compressed coding functionalities CCF₁ . . . CCFₙ(sensing matrices ϕ₁ . . . ϕₙ) are appropriately provided to the TDNN 55, which may be part of the imaging device or a remote server system, as described above. To this end, an assignment utility 70 is provided, which operates as a so-called decompression data provider, which utilizes a predetermined and stored data assignment data indicative of association between the compressed coding functionality(s) CCFᵢ (sensing matrix ϕᵢ) and the respective matching pixel segment (subset) PSᵢ for each i-th pixel segment (subset) of the pixel matrix. This enables the TDNN to perform decompression of each i-th compressed measured data piece CMDPᵢ using the respective/matching compressed coding functionality(s) CCFᵢ (sensing matrix ϕᵢ).

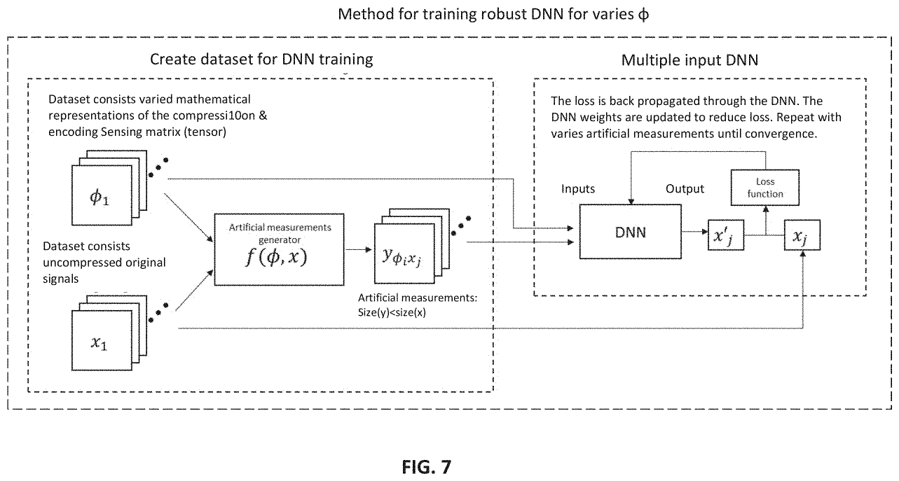

Reference is now made to FIG. 7 illustrating schematically, the principles of the training procedure applied to train the model, in particular a machine learning model such as, for example, the DNN to create the TDNN of the present invention. As shown in the figure in a self-explanatory manner, the training procedure includes creation of records (dataset) for the training.

These datasets include a plurality of records which associate a plurality of original/real (uncompressed) signals (images) x₁, . . . xₘ, with a plurality of varied coding functionalities (sensing matrices) in their mathematical representation by tensors ϕ₁-ϕₙ, to be applied to these original signals, i.e. each signal undergoes (compressed) coding by one or more of the multiple various sensing matrices. This data is input into an artificial measurement generator f(ϕ,x), which operates to generate corresponding data indicative of artificial measurements, i.e. multiple artificial coded measured signals (compressed coded images) yϕ₁×ⱼ. It should be understood that the size of the artificial coded measured data y is smaller than that of the input un-coded (un-compressed) data x.

The records associating the original signals, x₁, . . . xₘ together with the corresponding sensing matrices ϕ₁-ϕₙ and the resulting artificial compressed (coded) measured signals yϕᵢ×ⱼ (i=1 . . . n, j=1 . . . m) are fed (input) to the DNN thus training it to correlate between real signals, respective sensing matrices and corresponding compressed signals.

The training process is therefore an iterative process comprising a plurality of training iterations in which a plurality of real signals, for example, two or more each associated with each of a plurality of sensing matrices, for example, two or more are fed into the DNN together with a plurality of respective compressed signals. As such, in each training iteration the DNN is trained with a respective record which associates between a respective set which includes a respective one of the compressed signals coupled with a respective one of the real signals and a respective one of the plurality of sensing matrices which were used to create the respective compressed signal. In other words, in each iteration the DNN is trained with a record associating one of the compressed signals and the elements used to create it, i.e. the respective real signal and the respective sensing matrix.

Naturally, each of the real signals may be applied with a plurality of sensing matrices to create a plurality of different compressed signals which may be associated together to create a plurality of records used to train the DNN.

Moreover, the compression of the compressed signal used for training the DNN may be applied to a plurality of segments (subsets) of pixels of an image represented by the input signal, for example, the input light field originating from the signal source (e.g. scene) captured by the sensing device (imaging device) 10 where each of the plurality of pixel segments (pixel subsets) is compressed using one or more of the plurality of different sensing matrices (compressed coding functionalities).

Optionally, compression of the compressed signal used for training the DNN may be applied to one or more specific segments (subsets) of pixels of the image represented by the input signal, for example, the input light field originating from the signal source such that each specific pixel segment (pixel subset) is compressed using one or more of the plurality of different sensing matrices.

The compression of the compressed signal used for training the DNN may further include one or more of a plurality of different manufacturing imperfection patterns which may be typical and/or characteristic to the optical coder unit 15 and/or to the sensor unit 20 of the sensing device (imaging device) 10. As such one or more of the pixel segments (pixel subset) of the image represented by the input signal, for example, the input light field originating from the signal source are compressed using one or more of a plurality of different sensing matrices representing the plurality of different manufacturing imperfection patterns. Optionally, one or more of the pixel segments (pixel subset) of the image may be compressed using one or more of a plurality of different sensing matrices representing one or more manufacturing imperfection patterns of another sensing device (imaging device) 10, another model of the sensing device (imaging device) and/or the like.

The trained DNN may therefore be able to provide accurate signal reconstruction which is highly robust against such manufacturing imperfection that may be inherent and/or present in the sensing device (imaging device) 10.

The compression of the compressed signal used for training the DNN may further include one or more of a plurality of noise patterns which may affect the optical coder unit 15 and/or to the sensor unit 20 of the sensing device (imaging device) 10. As such one or more of the pixel segments (pixel subset) of the image represented by the input signal, for example, the input light field originating from the signal source are compressed using one or more of a plurality of different sensing matrices representing the plurality of different noise patterns.

The trained DNN may be therefore further robust to one or more noise effects which may be induced in compressed signals by one or more noise sources thus significantly increasing accuracy of the signal reconstruction.

The DNN utilizes a predictive model to perform decoding (decompression) of each signal, and compares between each pair of the corresponding decoded and real signals x′ⱼ and xⱼ in an iterative fitting procedure, while optimizing the predictive model, until a best fit condition between them is obtained, and stores the sensing matrix corresponding to the best fit condition, thereby creating the trained deep neural network TDNN. This enables the TDNN to be further used to identify the sensing matrix and the corresponding coded measured signal to apply the inverse problem solution and decode the received signal.

The following is a more specific description of the examples of the implementation of the present invention for the light field applications using the imaging device performing spectro-angular compressed coding functionalities.

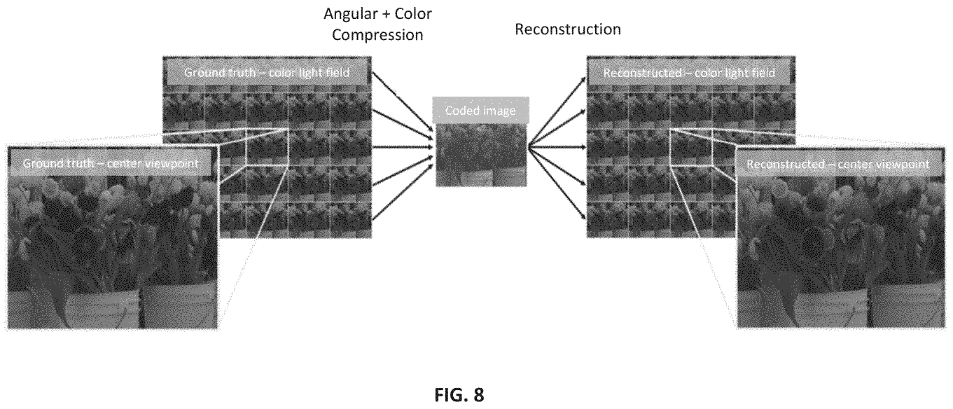

FIG. 8 demonstrates reconstruction of a color light field image from a 2D coded image projected at the sensor in a single shot. The compression of the color and angular information (i.e., angular coding and color coding) may be done by the optical system, using a random coded color mask placed between the angular coder (aperture) and the sensor. The compressed measurements may be acquired by a conventional camera with a random color mask. The use of the above-described TDNN enables to recover the full-color light field. The coded color mask used in the present invention enables to compress the color spectrum information of the light field in a single shot. The TDNN provides to achieve state-of-the-art reconstruction quality with low computational time. Moreover, the TDNN is designed to handle multiple types of mask patterns at the same time, allowing it to decompress a light field projected at various places on the sensor and by that, avoid the usage of multiple networks and excessive memory consumption.

The present invention may employ a fully convolutional network (FCN) trained end-to-end using color 4D light field patches (pixel segments also designated pixel subsets) to solve the compressed sensing task. The inventors have shown the use of an unsupervised-trained depth estimation network, which is concatenated with the TDNN, to extract depth maps directly from the compressed measurements, allowing to obtain the decompressed light field images with less than a second in computation time.

In the system of the invention, which is similar to that schematically shown in FIG. 4 and can be easily implemented in a conventional camera (where the angular compression is implemented by a camera aperture arrangement), unlike the previously proposed compressed light field approaches, there is no need for CFA, but only a monochrome sensor with a coded color mask located near the sensor can be used. Therefore, the color information (color coding) is also compressed in addition to the angular information (angular coding) but in a different way. This setup of FIG. 4 has two important advantages over using a CFA with a BW coded mask (1) It leads to a more practical implementation that uses only a single optical element instead of two. This allows implementing the compressed light field camera with only a monochrome sensor and a color mask. This advantage is crucial when building a real camera because the coded mask needs to be very close to the sensor itself and a CFA layer may prevent placing the mask in the desired location. (2) Using a single coded color mask, instead of a coded mask with a CFA, produces greater light efficiency. This is very important in view of the fact that light efficiency poses a major limitation (leads to low SNR) in the currently used compressed light field photography. Using one optical element instead of two improves this issue and makes it cheaper for production.

Following the plenoptic multiplexing approach in [37] and the representation of light field in [28], the contiguous color light field can be defined as

l_{λ}(x,v)=l(x,v,λ),

which denotes the ray that intersects the aperture plane at x and the sensor plane at v over the color spectrum λ.

A point at the sensor image is an integration (summation) over the aperture of all light rays that reach this point, over all the spectrum, coded by the mask between the sensor and the aperture:

i(x)=∫∫l(x,v,λ)M(x,v,λ)cos 4θdvdλ, (1)

where M(x,v,λ) is the modulation function characterized by the coded mask, and θ is the angle between the ray (x,v) and the sensor plane. The cos⁴ θ factor represents the Vignetting effect [29]. To the equation can be simplified by denoting:

\tilde{M}(x,v,λ)=M(x,v,λ)cos 4θ (2)

Thus, for a specific color spectrum, we get

i_{λ}(x)=∫l_{λ}(x,v)\tilde{M}(x,v,λ)d′v (3)

For a discrete light field (discrete viewpoints), there is a vectorized version of equation (3), and taking the noise into account, we have

i_{λ}=Φ_{λ}l_{λ}+n,Φ_{λ}=[Φ_{λ,1}Φ_{λ,2} . . . Φ_{λ,Nv2}] (4)

where i₈₀ ∈R^{m} is the vectorized sensor image, l_{λ}∈R^{k} is the vectorized light field, n∈R^{m} is an i.i.d zero mean Gaussian noise with variance. σ², and Φ_{λ,i}∈R^{m×m} is the modulation matrix of the i-th viewpoint over the spectrum λ; Φ_{λ}∈R^{m×k}^{_{λ}} is a concatenation of Φ_{λ,i}, i.e., it is the sensing matrix based on the modulation of the projected light field at the sensor (constituting/describing the compressed coding functionality).

Since Nᵥ is the angular resolution of the light field for a single axis, the discrete light field has N²_{ν} different viewpoints. Also, if the spatial resolution of the light field is Nₓ×Nₓ, then m=Nₓ² and k_{λ}=Nₓ²·Nᵥ².

For the RGB color space, λ∈{λ_{R},λ_{G},λ_{B}}, and equation (4) can be written as:

i=[Φ_{λR}Φ_{λG}Φ_{λB}]l+nΦl+n, (5)
where l=[l_{λR}l_{λG}l_{λB}]^{T}, Φ∈R^{m×k} and k=Nₓ²·Nᵥ²·3.

While equation (4) represents the sum of each discrete viewpoint, coded by its appropriate sensing matrix Φ_{λ,i}, in equation (5) there is also the summation over the three color channels. The compression ratio of the system is

$$\frac{m}{k} = \frac{1}{{N}_{v}^{2} \cdot 3}$$

which means that for Nᵥ²=25 viewpoints, the compression ratio is 1.3%. Also, the overall light which reaches the sensor is divided between each sub-aperture image among each of its color channels. Therefore, every color channel of sub-aperture image is attenuated by the same compression ratio, so the effective matrix is:

$$Φ = \frac{1}{{N}_{v}^{2} \cdot 3} \tilde{Φ}$$

where Φ^{˜} is the unattenuated matrix. Due to this phenomena, the reconstruction process has higher noise sensitivity as the compression ratio increases.

From compressed sensing perspective, the inverse problem that is to be solved is:

$${argmin}_{α} {‖ α ‖}_{0} s . t {‖ i - Φ D α ‖}_{2}^{2} < ϵ , \qquad ( 6 )$$

where k·k₀ is the l₀ pseudo-norm, ∈=∥n∥₂², D∈ [symbol] ^{k×s} is a given transform matrix or a learned dictionary and α∈R^{s} is the sparse representation of the light field 1. This problem is a NP-hard problem. It can be solved using a well-known greedy algorithm such as OMP or by relaxation to a '1 minimization problem, which is also known as basis pursuit denoising (BPDN) or LASSO, and has many solvers (e.g. [3], [4]).

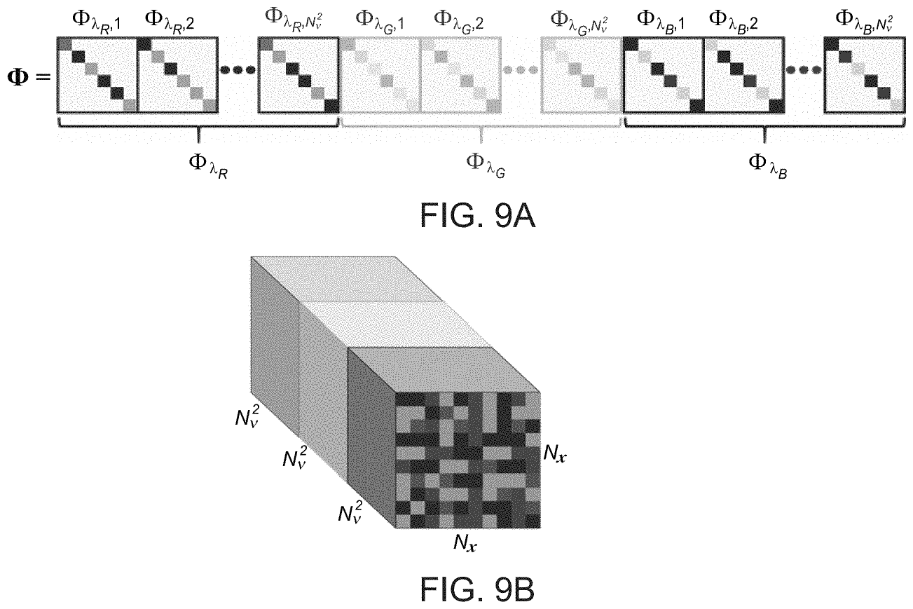

Due to physical constraints, Φ_{λ,i} are diagonal matrices and Φ is a concatenation of them. This is illustrated in FIG. 9A. Because of physical constraints, the sensing matrix for each viewpoint and color channel is a diagonal matrix; Φ∈R^{N}^{ₓ₂}^{×N}^{ₓ₂}^{·N}^{ᵥ₂}^{·3} is a concatenation of these matrices over all viewpoints and color channels. Therefore, ΦD has a high mutual coherence [7] and thus, no effective theoretical guarantee for successful reconstruction. However, empirical evidence has shown that the light field images can be still restored, even without these guarantees.

In order to multiplex the color information of the intersected rays into the projected 2D image at the sensor, a color mask (color coder 62 in FIG. 4) is used, which unlike Bayer CFA pattern, is random. The position of the color mask should be selected to enable to multiplex the angular information of the rays (provided by the angular coder). Therefore, the color mask should preferably not be placed directly on the sensor but slightly further. This position, in addition to the color pattern of the mask, allows having random weights for different angles and colors. It should be understood that the effective weights of the matrix Φ cannot be taken directly from the color mask, but by an accurate ray tracing computation over all the possible x,v and the number (e.g. three) of color channels. Therefore, the relationship between the mask and Φ is not direct, which means that one cannot choose Φ as he wishes. Therefore, the case is limited to random Φ only. Nevertheless, one still can choose the distribution from which Φ is generated and observe its effect on the reconstruction process.

A simpler approach to calculate Φ is to illuminate the sensor (pixel matrix) from each viewpoint, using e.g. white LED and three color filters. Then, the diagonal matrices Φ_{λ,i} can be easily deduced from the pattern projected at the sensor. Yet, for simplicity, in the simulation performed by the inventors, matrix Φ is assumed to be the same as the mask. To make it as realistic as possible, no assumption is made about periodic mask or any specific structure of it, because as mentioned above, periodicity in the mask does not imply periodicity in Φ. Instead, the inventors assume a random mask that implies that Φ is also random, which is more realistic.

From now on, Φ is considered a tensor of the size Nₓ×Nₓ N_{y}×N_{y}×3, where each index corresponds to the weight modulation of a specific ray (x,v,λ). This is illustrated in FIG. 9B corresponding to a tensor Φ in which the angular dimensions and the color dimension are concatenated together. Φ can be also expressed as a 5-D tensor. Each element in it is the modulation weight for a specific ray (x,v,λ). This is the tensor Φ used as a part of the input to the TDNN. Compression of the color and angular information is described as

i=Φ(I)=S(Φ⊙I),

where (·) is an element-wise multiplication and S(·) is a summation operator over the color and angular axes.

Three different distributions of the color mask are evaluated: (i) Uniform distribution Φ ˜U[0,1]; (ii) RGB, where each pixel on the mask has the same probability of being red, green or blue; and (iii) RGBW, where each pixel is either red, green, blue or white (let all colors pass) with the same probability. The last two cases are more realistic since they are easier to be manufactured (similar to CFA).

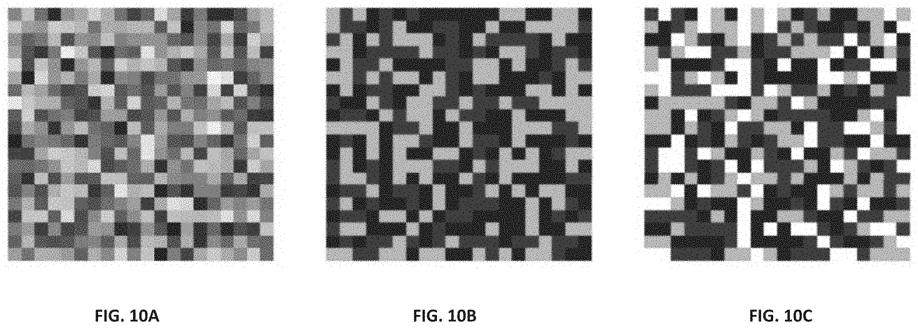

FIG. 10A, FIG. 10B and FIG. 10C show 20×20 examples of the generated masks for, respectively, uniform distribution, RGB distribution, and RGBW distribution. Among these distributions, RGBW produced the best results in the experiments conducted by the inventors. The following table shows average results for the validation set presented as PSNR/SSIM.

32.30/0.97

| | Test data | | |
|---|---|---|---|
| Train data | Uniform | RGB | RGBW |
| Uniform | 29.61/0.96 | 26.97/0.90 | 29.41/0.95 |
| RGB | 23.84/0.84 | 29.79/0.94 | 22.29/0.77 |
| RGBW | 30.8/0.96 | 27.46/0.91 | 32.30/0.97 |

Each row corresponds to a different network, which was trained with a certain Φ distribution. Each column corresponds to distribution in the color mask used to create the test data. It is evident that using a RGBW mask with a network trained on data from this distribution produces the best results. The inventors also tested each network on a different distribution of which it was not trained on. The network which was trained on uniform distributed (P succeeded to generalize to RGBW data well while having more difficulty to do so for RGB. These results are expected because the RGBW and Uniform masks transmit 50% of the light/information while the RGB mask transmits only third of it. These results point that RGBW mask is superior not only in terms of reconstruction quality but also the ability of the network to generalize to other distribution.

The inventors have used a FCN which enables the processing of large patches (pixel segments) (the inventors uses a size of 100×100 pixel segment (subset)). To make the network robust to the location of the patch, i.e. the pixel segment (pixel subset) in the image, it receives as an input also the corresponding part in matrix Φ. This allows training a single network for the whole light field scene.

The following is the description of the network design, which allows fast reconstruction, and the comparison made by the inventors between the results of the TDNN of the invention and dictionary-based methods and some other deep learning methods.

As indicated above, the network receives as an input the compressed image (compressed measured data or data piece) and its matching sensing tensor:

[symbol]

=f(i,Φ), (7)

where [symbol] is the reconstructed light field patch (pixel segment), and i and Φ are the compressed patch (pixel segment) and its matching sensing tensor of corresponding location at the sensor. Due to memory limitations, in the training time the network used in the invention does not process the whole images at once but in a patch-based (pixel segment based) manner. During test time, the advantage of the FCN architecture is taken to process the whole compressed image at once.

The inventors have chosen convolutional neural network as a regression model for the reconstruction. Convolutional networks allow to process large patches (pixel segments) with a low computational time. The network architecture used by the inventors is a dilated convolutional network [38]. Dilated convolutions enable the expansion of the receptive fields of the network using a small filter size, without performing any pooling or sampling. This enables to keep the original resolution of the network without making the network too deep, which may harm the computation time and lead to over-fitting. This type of network was originally created for semantic segmentation. The inventors have found that it is also suitable for the compressed sensing reconstruction task.

Each convolution layer in the network is followed by an exponential linear unit (ELU) [6] and batch normalization [15], except at the last layer, where a sigmoid is used in order to force the output to be in the range [0,1]. All filters are of size 3×₃ without any exception. The dilations used in the network are with exponentially increasing rates [38]. We inventors have found that training with big patches (pixel segments) leads to better reconstruction. Therefore, the network used by the inventors is trained with patches (pixel segments) of size 100×100×5×5×3 (the 5×5×3 stands for the number of reconstructed angles and the color channels).

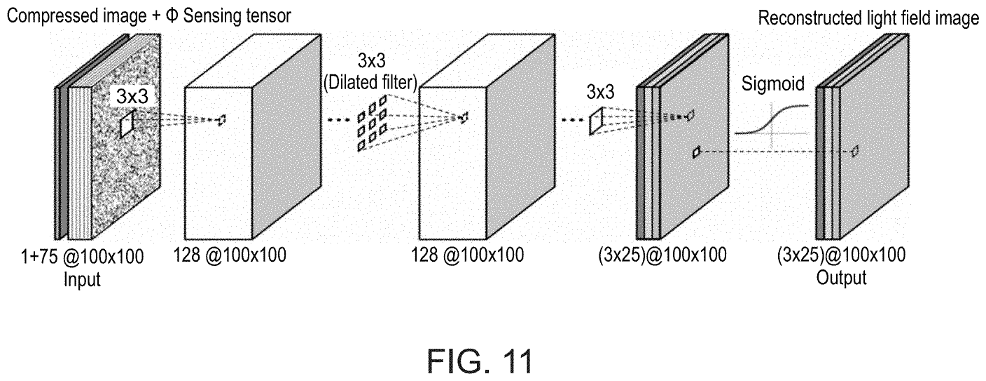

As shown schematically in FIG. 11, the reconstruction network used by the inventors consists of 11 3×3 convolutional layers with 128 channels. The middle four layers are dilated convolutional layers with exponentially increasing rates of 2-4-8-16. All the layers, except the last one, are followed by a batch normalization and ELU. The last layer is followed by a sigmoid enforcing the output range to [0, 1]. The model size is 17.23 MB. The simulated mask is randomly generated as a RGBW color mask. The network input is a concatenation of the compressed image and the sensing tensor (as shown in FIG. 9A and FIG. 9B). The output is the decompressed color light field, which consists of 5×5 viewpoints across 3 color channels (thus, there are 3×25 channels in the last two layers).

Thus, the input to the network is the compressed color light field patch (pixel segment), concatenated with its matching Φ tensor. Adding Φ to the input improves the reconstruction, but more importantly, allows the DNN to adapt to the distribution of the given Φ. In fact, this important property makes the network useful for reconstructing patches, i.e. the pixel segments (pixel subsets) from different places at the sensor, which corresponds to different sensing matrices. Therefore, this allows to train only one network for the whole sensor, which leads to a very small memory usage and computational time compared to the case where a different network is used for each patch (pixel segment). For example, in case of 1-megapixel sensor and 100×100 patch (pixel segment) size with 50 pixels stride, there would be a need to train 324 different networks, which sums up to a size greater than 5.5 GB. The technique of the invention saves all this effort and memory consumption as it allows easy manufacturing of a light field camera.

For the purposes of network training, the set of light field patches (pixel segments) from the training images is marked as T. Also, a dataset of different Φ tensors is created which correspond to all the locations on the sensor that are used during recovery (which are sets according to a wanted stride size). This data set is marked as M. For each batch of size B, light field patches (pixel segments) were randomly selected from T and sensing tensors were randomly selected from M. Then, their matching compressed patches (pixel segments) {i_{q}}_{q=1}^{B} were selected:

i_{q}=Φ_{q}(l_{q})+n,l_{q}∈T,Φ_{q}∈M, (8)

where the training set is the group of tuples {(i_{q}, Φ_{q}, l_{q})}_{q=1}^{B}, in which every tuple consists of the ground truth light field patch (pixel segment) l_{q}, its corresponding sensing tensor Φ_{q} and its compressed measurement i_{q}; n is the model's sensor noise n˜ [symbol] (0, σₛₑₙₛₒᵣ²). By this, combinations of various light field patches (pixel segments) are created with randomly chosen locations in the sensing tensor.

The network training loss function consists of two parts:

$$ℒ = {\sum }_{q}^{ } \underbrace{{‖ {\hat{I}}_{q} - {I}_{q} ‖}_{1}}_{{ℒ}_{data}} + β \underbrace{{‖ {Φ}_{q} ( {\hat{I}}_{q} ) - {i}_{q} ‖}_{2}^{2}}_{{ℒ}_{CS}} , \qquad ( 9 )$$

where β is a hyper parameter balancing L_{data} and L_{cs}. The data term L_{data} is the l₁ distance between the reconstructed light field patch (pixel segment) and the ground-truth patch (pixel segment). Once the network training converges, fine tuning of the network is performed using the l₂ distance in L_{data} instead of the l₁ norm. This action improves the recovery accuracy by 0.5 PSNR. The inventors have chosen this combination of l₁ and l₂ as it has been shown to be more effective than using just l₁ or l₂ [40]. The second term Ls imposes consistency with the measurements model.

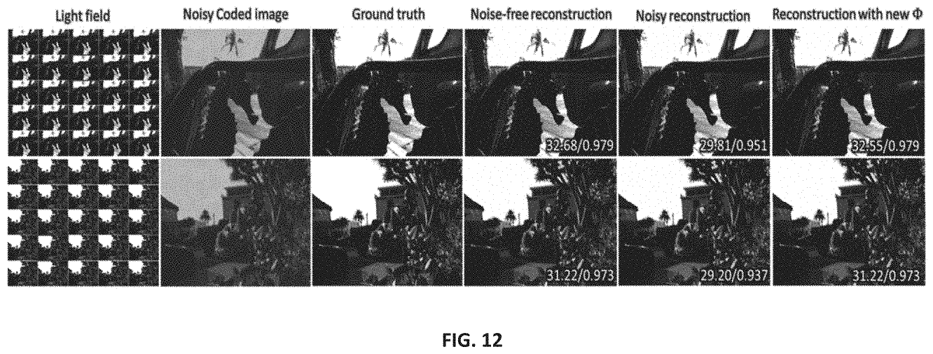

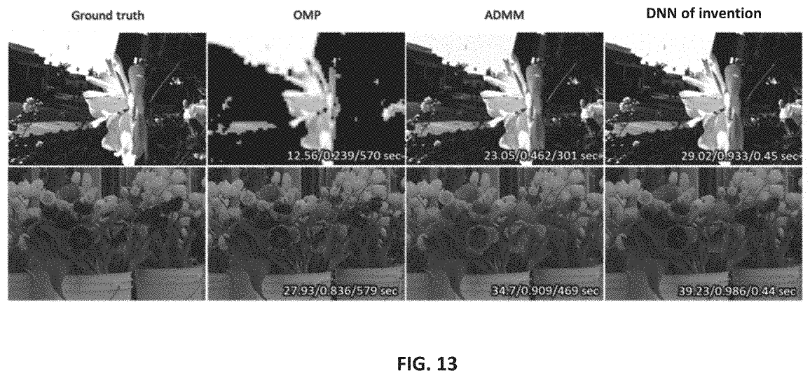

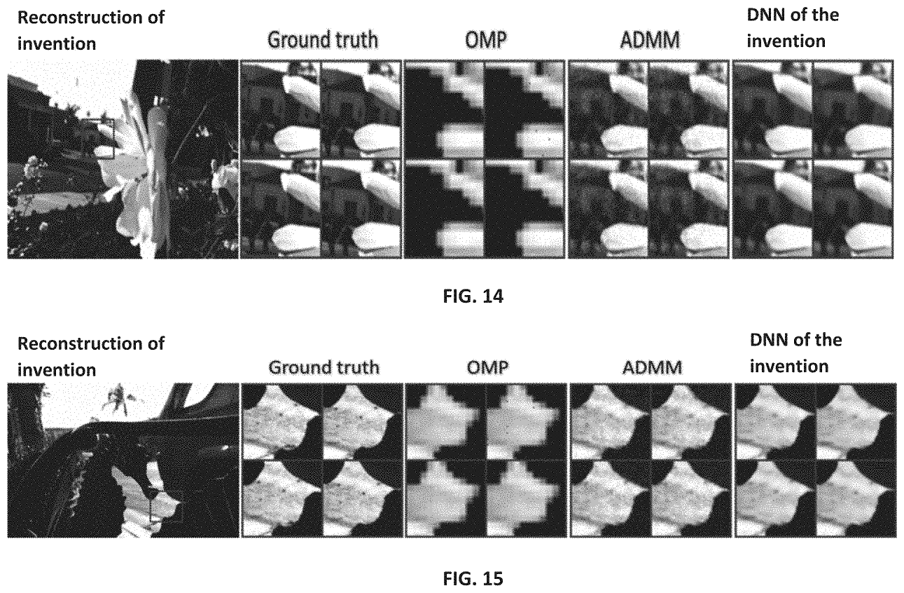

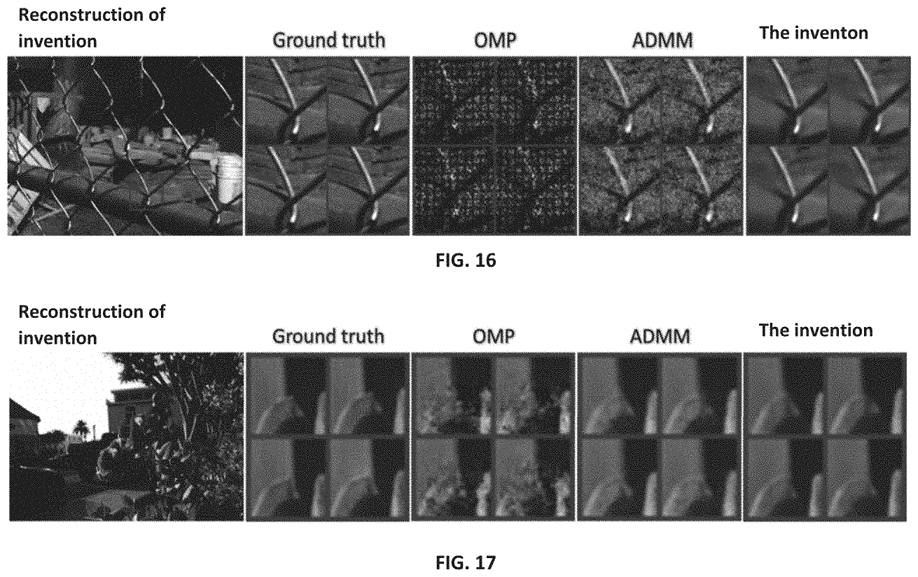

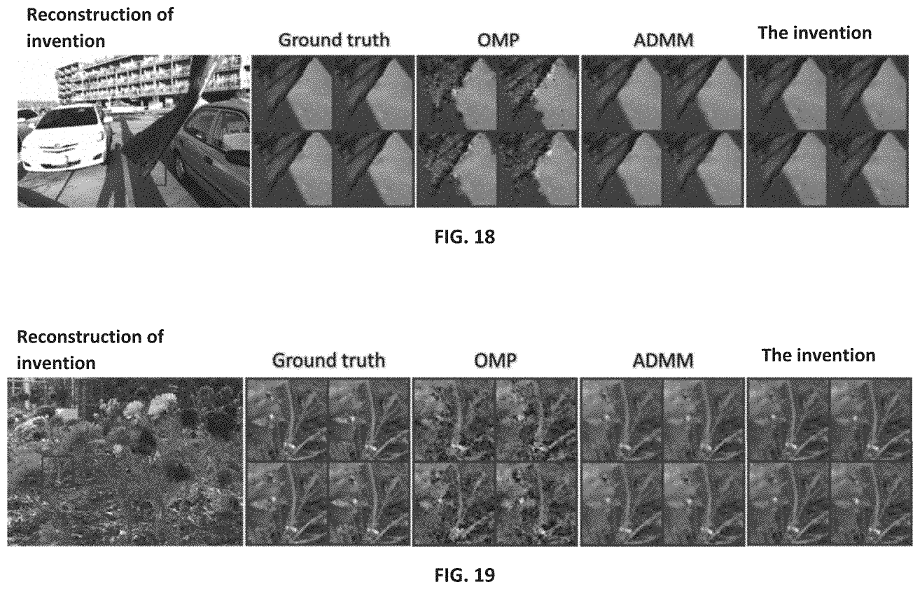

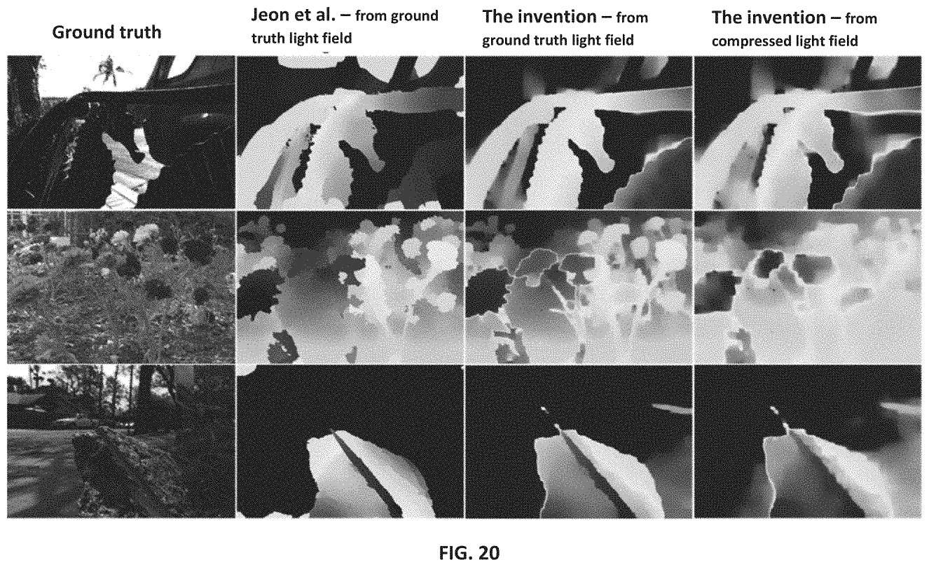

Reference is made to FIG. 12 illustrating the results of the image reconstruction technique in an experiment conducted by the inventors with respect to the two test light images from a test set. The network's reconstruction time takes less than 0.5 sec for the whole light field images. It should be noted that the results of the network of the invention are with high spatial quality and that in the noisy case they have lower color fidelity. It should also be noted that the inventors present the reconstruction results for compressed light field with Φ that was never been observed in training. This demonstrates the robustness of the approach of the invention.

The following are the results of some experiments conducted by the inventors for color light field decompression on the Stanford Lytro dataset [33] and the Lytro dataset provided by Kalantari et al. [18]. In addition, the inventors have shown the reconstructed disparity maps from the compressed image. All of the networks used have been trained in tensor flow using color patches (pixel segments) of size 100×100 with an angular resolution of 5×5 (25 viewpoints). The training has been done with mini-batches of size 32, the filters have been initialized using Xavier initialization [10], and the ADAM optimizer [19] has been used with β₁=0.9, β₂=0.999 and an exponentially decaying learning rate. The dataset includes 79 light field images of size 376×541×5×5×3, which means that there are over 9 million 100×100 patches (pixel segments) in it, which are different by at least a single pixel from each other. The inventors have chosen 7 light field images as the test set while the rest have been kept for training.

For the reconstruction network, the inventors set β=0.004 and the initial learning rate to 0.0005. While for the disparity network, they set γ=0.1 in equation (11) and the initial learning rate to 0.001.

FIG. 13 shows the comparison between the reconstruction network of the invention and dictionary-based methods. The presented numbers are PSNR/SSIM/reconstruction time. The noisy case with σₛₑₙₛₒᵣ=0.02 is shown in the top images, and the bottom images show noiseless case. It should be noted that the technique of the invention is both faster and more accurate than the sparse coding based approaches.

The inventors conducted some more experiments to compare the results of the technique of the invention with other light field images from Stanford Lytro archive [33] and the Lytro dataset provided by Kalantari et al. [18], for the noiseless and noisy cases. Each example includes the full light field reconstruction of the invention and a close-up of the mark area from the four corner viewpoints of the reconstruction of each of the following methods: OMP, ADMM and the present invention. In each example, the area with a significant disparity is marked in the original light field.

The comparison results are demonstrated in FIG. 14, FIG. 15 and FIG. 16 showing the noise case examples for, respectively, white flower, seahorse, and fence. As indicated above, besides the noise and low-quality resolution in the sparsity-based reconstruction, there is also a loss of the angular resolution. It can be well observed in the OMP recovery of the White flower and Seahorse images in the noisy case (FIG. 15 and FIG. 16). OMP recovery loses the difference between the angles. In the noisy case, all techniques including that of the invention encounter hardships in the color restoration. Due to high compression ratio, the noise causes errors in the color fidelity of the reconstructed light field (see FIG. 17). Nevertheless, the reconstruction technique of the invention still has high spatial and angular resolution in this case, which can be used for depth estimation, as will be described further below. Also, it still outperforms the sparsity-based methods, which provide poor recovery. FIG. 17, FIG. 18 and FIG. 19 present noiseless case examples of the comparison results for, respectively, purple flower, cars, and garden.

For the light field reconstruction, the inventors evaluated two scenarios. One with clean observations and the second with noisy ones with σₛₑₙₛₒᵣ=0.02. The inventors present the average PSNR and SSIM across the 7 test light field images. Both networks were trained with 800 epochs, each includes randomly chosen 4000 patches (pixel segments). Φ was randomly chosen without any optimization as described above. The reconstructed light field patches (pixel segments) were restored with their matching Φ tensors using only the TDNN of the invention for the whole image. The inventors compared the results with dictionary-based methods. The dictionary was trained on color light field 8×8 patches (pixel segments). It was trained using online dictionary learning [18] in order to overcome memory limits, which was initialized using K-SVD [2] trained on a smaller dataset. The reconstruction was made with OMP and ADMM with patch (segment) overlapping of 2 pixels, using Intel i7-6950X CPU with 10 cores. The TDNN of the invention used NVIDIA GeForce GTX 1080 Ti both for training and testing.

Turning back to FIG. 12 described above, presenting the quality of the reconstruction according to the invention for two light field images out of the test set, the figure shows the high accuracy in the reconstruction of the various details in the image. Yet, in the noisy case, the reconstructed image suffers from lower color fidelity because of the high compression ratio. Nevertheless, in this case, the reconstructed images have high spatial quality. To check the ability of the TDNN to generalize to new compression patterns of Φ, the inventors have tested the TDNN with an entirely new randomly generated Φ, whose patterns have never been observed by the network in training time. The results show that switching to the new Φ has not affected the results at all. This approves that the TDNN of the invention generalizes well to new compression patterns, which are generated from the same distribution it was trained with. FIG. 13 described above makes a comparison between the TDNN and sparsity-based methods (OMP and ADMM) for other two light field images from the test set. At the noiseless example (bottom), the reconstruction by the TDNN has the highest color fidelity and spatial quality, while the other methods suffer from artifacts and low saturation of the colors. In the noisy case (top), OMP fails to recover the details and colors of the image almost completely while losing all the angular resolution. Also, ADMM suffers from noisy reconstruction while the TDNN's output is clean and has high reconstruction quality. Moreover, the technique of the invention provides 3 orders of magnitude less time than the sparsity methods.

The following Tables I and Table II summarize the average PSNR and SSIM both for the noisy and noiseless cases. In the noiseless case, comparison is also made to results presented in Gupta et al. [12].

Table 1 shows the average results of 3 images reported in [12] for the Lytro test set in the noiseless case. In [12], the reconstruction is made for each color channel separately and compression is performed using ASP.

| | PSNR | SSIM | Reconst. time | |
|---|---|---|---|---|
| Ours | 32.05 | 0.98 | 0.15 | sec |
| OMP | 18.61 | 0.71 | 562 | sec |
| ADMM | 27.29 | 0.88 | 345 | sec |
| Gupta et al. [16] | 30.9* | — | 80 | sec |

Table 2 shows the average results in the noisy case. Here, the comparison is made with the results of the invention and sparsity-based methods.

| | PSNR | SSIM | Reconst. time | |
|---|---|---|---|---|
| Ours | 28.9 | 0.93 | 0.15 | sec |
| OMP | 12.93 | 0.17 | 556 | sec |
| ADMM | 24.16 | 0.52 | 294 | sec |

It can be clearly seen that the technique of the invention is superior in terms of reconstruction quality, computational time and has higher robustness to noise. The average reconstruction time of the TDNN in both cases is 0.15 sec for a single light field scene, which is faster by 2-3 orders of magnitude compared to other previous existing solutions.

According to the reported results in [12], the reconstruction of noise-free images with their network on 3 reported images (Seahorse, Purple flower and White flower) has worse PSNR than that of the present invention on the same images and takes almost two order of magnitude more time compared to the reconstruction technique of the invention using Titan X GPU (Table I). It should also be noted that the prior art network does not deal with color compression but decompress each channel separately. Also, the prior art network is not robust to different types of Φ but is adjusted to only one pixels segment (patch) pattern, which means that there is a need to train a different network for each pixels segment (patch). Indeed, it uses ASP [15], which creates a different Φ compared to coded mask.

In order to evaluate the disparity network of the invention, the inventors examined its depth estimation quality given the ground truth light field and also given the recovered light field of the reconstruction TDNN. The inventors compared the disparity maps of the invention to the disparity estimation of Jeon at el. [17], which is considered to be the state-of-the-art for disparity evaluation from light field images. Their method uses no learning and relies on graph-cuts of a big cost volume.

FIG. 20 shows the recovery of each method. The TDNN succeeds to preserve more image details and structure. Moreover, it has less false predictions in the background pixels. In computation time, the TDNN requires less than a second to calculate the disparity map using NVIDIA GeForce GTX 1080 Ti, while Jeon et al. technique takes over 80 seconds using Intel i7-6950X CPU with 10 cores.

Thus, the present invention provides a novel approach for reconstructing compressed measured data (e.g. a color light field from compressed measurements coded with a random color mask). The processing is performed by an efficient neural network that uses a small amount of memory, has low computational time and is robust to different compression patterns. The inventors have also shown how a reconstructed light field can be used to estimate the depth of the scene using another neural network.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms ML models, neural network and deep neural network are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A training method for training a model, comprising:
in each of a plurality of training iterations:
receiving a record associating at least one compressed signal created according to a sensing matrix selected from a plurality of sensing matrixes with at least one signal originated from a signal source and used for compressing the at least one compressed signal according to the selected sensing matrix;
feeding the record and the sensing matrix to train a model;
outputting the trained model for reconstructing at least one new signal originated from the signal source;
wherein at least two of the plurality of sensing matrixes are fed during at least two separate iterations of the plurality of training iterations.

2. The training method of claim 1, wherein said model is a deep learning network (DNN).

3. The training method of claim 1, wherein said at least one signal is coded by representation in a predetermined multi-dimensional parametric space.

4. The training method of claim 1, wherein said at least one signal is at least one light signal arriving from a scene in an imaged region of interest projected on a pixel matrix of a sensor to form on said pixel matrix a compressed image indicative of said at least one signal.

5. The training method of claim 1, wherein the at least one compressed signal is generated by angular coding of the at least one signal.

6. The training method of claim 1, wherein the at least one compressed signal is generated by color coding of the input light.

7. The training method of claim 1, wherein the compressing is applied to each of a plurality of segments of an image represented by the at least one signal, each of the plurality of segments is associated with one of a plurality of different sensing matrices.

8. The training method of claim 1, wherein the compressing is applied to a plurality of different random patterns on the same image segment represented by the at least one signal, each of the plurality of random pattern is associated with one of a plurality of different sensing matrices.

9. The training method of claim 1, wherein the compressing is applied to a plurality of different manufacturing imperfection patterns on the same image segment represented by the at least one signal, each of the plurality of different manufacturing imperfection patterns is associated with one of a plurality of different sensing matrices.

10. The training method of claim 1, wherein the compressing is applied to a plurality of random noise patterns on the same image segment represented by the at least one signal, each of the plurality of random noise patterns is associated with one of a plurality of different sensing matrices.

11. A system for training a model, comprising:
at least one processor executing a code, the code comprising:
code instruction to conduct a plurality of training iterations, each of the plurality of training iterations comprising:
receiving a record associating at least one compressed signal created according to a sensing matrix selected from a plurality of sensing matrixes with at least one signal originated from a signal source and used for compressing the at least one compressed signal according to the selected sensing matrix;
feeding the record and the sensing matrix to train a model;
outputting the trained model for reconstructing at least one new signal originated from the signal source;
wherein at least two of the plurality of sensing matrixes are fed during at least two separate iterations of the plurality of training iterations.

12. A method for reconstructing signals originated from signal sources, comprising:
receiving at least one compressed signal originated from a signal source;
identifying a sensing matrix used for compressing the at least one compressed signal;
feeding the at least one compressed signal and the sensing matrix to a trained model; and
reconstructing at least one signal originated from the signal source according to an output of the trained model;
wherein the trained model is adapted to reconstruct a common signal differently when being fed with different sensing matrixes.

13. The method of claim 12, wherein the at least one compressed signal is generated by angular coding of the at least one signal.

14. The method of claim 12, wherein the at least one compressed signal is generated by color coding of the input light.

15. The method of claim 12, wherein the compressing is applied to each of a plurality of segments of an image represented by the at least one signal, each of the plurality of segments is associated with one of a plurality of different sensing matrices.

16. The method of claim 12, wherein the compressing is applied to a plurality of different random patterns on the same image segment represented by the at least one signal, each of the plurality of random pattern is associated with one of a plurality of different sensing matrices.

17. The method of claim 12, wherein the compressing is applied to a plurality of different manufacturing imperfection patterns on the same image segment represented by the at least one signal, each of the plurality of different manufacturing imperfection patterns is associated with one of a plurality of different sensing matrices.

18. The method of claim 12, wherein the compressing is applied to a plurality of random noise patterns on the same image segment represented by the at least one signal, each of the plurality of random noise patterns is associated with one of a plurality of different sensing matrices.

19. A system for reconstructing signals originated from signal sources, comprising:
at least one processor executing a code, the code comprising:
code instruction to receive at least one compressed signal originated from a signal source;
code instruction to identify a sensing matrix used for compressing the at least one compressed signal;
code instruction to feed the at least one compressed signal and the sensing matrix to a trained model; and
code instruction to reconstruct at least one signal originated from the signal source according to an output of the trained model;
wherein the trained model is adapted to reconstruct a common signal differently when being fed with different sensing matrixes.
